(19) United States
(12) Patent Application Publication
(10) Pub. No.: US 2026/0122584 A1
(43) Pub. Date: Apr. 30, 2026

(54) CAPABILITY INFORMATION REPORTING METHOD, COMMUNICATION METHOD, AND RELATED APPARATUS

(71) Applicant: HUAWEI TECHNOLOGIES CO., LTD., Shenzhen (CN)

(72) Inventors: Ying Chen, Hangzhou (CN); Peng Zhang, Shenzhen (CN); Jun Wang, Hangzhou (CN)

(21) Appl. No.: 19/421,164

(22) Filed: Dec. 16, 2025

Related U.S. Application Data
(63) Continuation of application No. PCT/CN2024/099499, filed on Jun. 17, 2024.

(30) Foreign Application Priority Data
Jun. 26, 2023 (CN) 202310760477.9

(51) Int. Cl. H04W 52/36; H04W 8/22

(52) U.S. Cl. CPC H04W 52/367; H04W 8/22

(57) ABSTRACT

A capability information reporting method, a communication method, and a related apparatus. The terminal device determines the N groups of capability information. Each of the N groups of capability information includes at least one of the following: a rated output power, a power back-off amount, an antenna gain, an output power density, a type of an antenna in the terminal device, a maximum output power, a minimum output power, or an antenna capability level, and Nis an integer greater than or equal to 1. The terminal device sends the N groups of capability information to the network device.

### CROSS-REFERENCE TO RELATED APPLICATIONS

This application is a continuation of International Application No. PCT/CN2024/099499, filed on June 17, 224, which claims priority to Chinese Patent Application No. 202310760477.9, filed on Jun. 26, 2023. The disclosures of the aforementioned applications are hereby incorporated by reference in their entireties.

### TECHNICAL FIELD

This application relates to the field of communication technologies, and in particular, to a capability information reporting method, a communication method, and a related apparatus.

### BACKGROUND

Compared with terrestrial communication, non-terrestrial communication has unique advantages. For example, non-terrestrial communication may provide a wider coverage area. The non-terrestrial communication may be satellite communication, high-altitude platform station communication, or the like. Non-terrestrial network devices are not vulnerable to damage from natural disasters or external forces. Non-terrestrial communication is introduced into a 5th generation (5th generation, 5G) communication system, so that a communication service can be provided for some areas that cannot be covered by a terrestrial communication network, such as the ocean or a forest, and reliability of the 5G communication system can be further enhanced. For example, it is ensured that aircrafts, trains, and users on these transportation vehicles obtain higher-quality communication services, and more data transmission resources are provided for 5G communication to improve a network speed. Therefore, supporting both terrestrial communication and non-terrestrial communication is an inevitable trend of a future 5G communication system, and has benefits in terms of wide coverage, reliability, multi-connectivity, a high throughput, and the like.

Currently, satellite communication has been introduced into the 3rd generation partnership project (3rd generation partnership project, 3GPP) standard, and is used as a communication scenario of 5G communication. In the 3GPP standard, to adapt to features of a high delay and high mobility, a timing technology, a synchronization technology, a hybrid automatic repeat request (hybrid automatic repeat request, HARQ) technology, and other technologies are correspondingly enhanced. Due to long distances in satellite communication, in addition to conventional terminals, terminals with ultra-high capabilities need to be defined to improve communication quality. The terminal with an ultra-high capability is not affected by a size and power supply, and may transmit a high output power. Therefore, an output power architecture defined for the conventional terminal is no longer applicable to the terminal with an ultra-high capability.

Therefore, how the network device needs to communicate with the terminal with an ultra-high capability is a problem worth considering.

### SUMMARY

This application provides a capability information reporting method, a communication method, and a related apparatus for a terminal device to report N groups of capability information to a network device, so that the network device communicates with the terminal device.

A first aspect of this application provides a capability information reporting method. The method is performed by a terminal device. The terminal device may be a device or an apparatus with a chip, or a device or an apparatus integrated with a circuit, or a chip, a chip system, a module, or a control unit in the foregoing device or apparatus. This is not specifically limited in this application. It should be noted that, in this application, reference to the terminal device may mean the terminal device itself, or may mean a chip, a functional module, an integrated circuit, or the like that is in the terminal device and that completes the method provided in this application. This is not specifically limited in this application. In the first aspect and possible implementations of the first aspect, an example in which the method is performed by the terminal device is used for description. The capability reporting method provided in this application includes:

The terminal device determines N groups of capability information, where each of the N groups of capability information includes at least one of the following: a rated output power, a power back-off amount, an antenna gain, an output power density, a type of an antenna in the terminal device, a maximum output power, a minimum output power, or an antenna capability level, and N is an integer greater than or equal to 1. The terminal device sends the N groups of capability information to the network device, so that the network device communicates with the terminal device based on the N groups of capability information. It can be learned that the terminal device may be a terminal with an ultra-high capability, and the terminal with an ultra-high capability may report the N groups of capability information supported by the terminal, so that the network device communicates with the terminal with an ultra-high capability. For example, the network device performs power control and/or service type selection on the terminal with an ultra-high capability based on the N groups of capability information.

A second aspect of this application provides a communication method. The method is performed by a network device. The network device may be a device or an apparatus with a chip, or a device or an apparatus integrated with a circuit, or a chip, a chip system, a module, or a control unit in the foregoing device or apparatus. This is not specifically limited in this application. It should be noted that, in this application, reference to the network device may mean the network device itself, or may mean a chip, a functional module, an integrated circuit, or the like that is in the network device and that completes the method provided in this application. This is not specifically limited in this application. In the second aspect and possible implementations of the second aspect, an example in which the method is performed by the network device is used for description. The communication method provided in this application includes:
The network device receives N groups of capability information from a terminal device, where each of the N groups of capability information includes at least one of the following: a rated output power, a power back-off amount, an antenna gain, an output power density, a type of an antenna in the terminal device, a maximum output power, a minimum output power, or an antenna capability level, and N is an integer greater than or equal to 1. The network device communicates with the terminal device based on the N groups of capability information. It can be learned that the terminal device may be a terminal with an ultra-high capability, and the terminal with an ultra-high capability may report the N groups of capability information supported by the terminal, so that the network device communicates with the terminal with an ultra-high capability. For example, the network device performs power control and/or service type selection on the terminal with an ultra-high capability based on the N groups of capability information.

Based on the first aspect or the second aspect, in a possible implementation, the terminal device supports Nmax groups of capability information, where N is less than or equal to Nmax, and Nmax is an integer greater than or equal to 2. In this implementation, the terminal device may be a terminal with an ultra-high capability, and the terminal device supports at least two or more groups of capability information.

Based on the first aspect or the second aspect, in a possible implementation, the N groups of capability information include N indexes, and each of the N indexes corresponds to one of the N groups of capability information. In this implementation, the terminal device may indicate the N groups of capability information by using the N indexes, to indicate the N groups of capability information to the network device, so that signaling overheads generated by indication of the N groups of capability information are reduced.

Based on the first aspect or the second aspect, in a possible implementation, in the N groups of capability information, different groups of capability information differ in at least one of the following corresponding parameters, where the at least one parameter includes at least one of the following: a modulation scheme used by the terminal device, a modulation order used by the terminal device, a code rate used by the terminal device, spectral efficiency used by the terminal device, a waveform used by the terminal device, a polarization manner used by the terminal device, a position of a time-frequency resource allocated to the terminal device, a communication scenario of the terminal device, or a motion status of the terminal device. In this implementation, each group of capability information differs in at least one of the foregoing corresponding parameters, to indicate, to the network device, capability information supported by the terminal device under a corresponding working condition, so that the network device communicates with the terminal device based on the N groups of reported capability information.

Based on the first aspect or the second aspect, in a possible implementation, a maximum output power P_{CMAX,f,c} of the terminal device satisfies the following condition:

$${P}_{CMAX \_ L , f , c} \leq {P}_{CMAX , f , c} \leq {P}_{CMAX \_ H , f , c}$$

$${P}_{CMAX \_ L , f , c} = min ( {P}_{EMAX , c} , {P}_{MOP \_ Low} , P 1 - {P}_{\_ {MPR}_{c}} ) ,$$

P_{CMAX_H,f,c}=min(P_{EMAX,c}, P_{MOP_High}), P_{EMAX, c} represents an upper limit value configured by the network device for an output power of the terminal device, a value of P_{EMAX,c} is in a range of [X, Y], X represents a minimum value of P_{EMAX,c}, Y represents a maximum value of P_{EMAX,c}, P_{MOP_Low} represents a minimum output power supported by the terminal device, P_{MOP_High} represents a maximum output power supported by the terminal device, P_{_MPR}_{_{c}} represents a maximum power back-off value supported by the terminal device, and P1 is equal to P_{MOP_High} or is a maximum output power that is specified by the network device and that is supported by a terminal type of the terminal device.

In this implementation, the maximum output power of the terminal device is specified, so that the terminal with an ultra-high capability communicates with the network device by using a corresponding output power.

Based on the first aspect or the second aspect, in a possible implementation, X is less than or equal to −30 dB (decibels), and Y is greater than 33 dB. In this implementation, a value of X and a value of Y are specified. It can be learned that, for the terminal with an ultra-high capability, the upper limit value of P_{EMAX,c} is higher than an upper limit value configured by the network device for an output power of a conventional terminal device.

Based on the first aspect or the second aspect, in a possible implementation, X=−30 dB, and Y=64 dB. It can be learned that, for the terminal with an ultra-high capability, the upper limit value of P_{EMAX,c} is higher than the upper limit value configured by the network device for the output power of the conventional terminal device, so that the terminal with an ultra-high capability communicates with the network device by using a high output power.

Based on the first aspect or the second aspect, in a possible implementation, a minimum output power P_{CMIN,f,c} of the terminal device satisfies the following condition:

$${P}_{CMIN , f , c} = P 2 - {P}_{\_ {MPR}_{c}}$$

P2 represents a rated output power of the terminal device under a condition without power back-off, and P_{_MPR}_{_{c}} represents the maximum power back-off value supported by the terminal device. In this implementation, the minimum output power of the terminal device is specified, so that the terminal with an ultra-high capability communicates with the network device by using a corresponding output power.

Based on the first aspect or the second aspect, in a possible implementation, a value of P2 is in a range of [a, b], a is greater than 23 dB and less than or equal to 31 dB, and b is greater than 31 dB. It can be learned that, for the terminal with an ultra-high capability, the upper limit value of P2 is higher than the upper limit value configured by the network device for the output power of the conventional terminal device, so that the terminal with an ultra-high capability communicates with the network device by using a high output power.

Based on the first aspect or the second aspect, in a possible implementation, a=29 dB, and b=60 dB. It can be learned that, for the terminal with an ultra-high capability, the upper limit value of P2 is higher than the upper limit value configured by the network device for the output power of the conventional terminal device, so that the terminal with an ultra-high capability communicates with the network device by using a high output power.

Based on the first aspect or the second aspect, in a possible implementation, the type of the antenna in the terminal device includes one or more of the following: a parabolic antenna, a phased-array antenna, an omnidirectional antenna, a directional antenna, an active antenna, or a passive antenna. In this implementation, some possible antenna types of the terminal device are shown. When the terminal with an ultra-high capability has a plurality of types of antennas, the terminal with an ultra-high capability may report a corresponding antenna type, so that the network device better communicates with the terminal with an ultra-high capability.

A third aspect of this application provides a first communication apparatus. The first communication apparatus may be a device or an apparatus with a chip, or a device or an apparatus integrated with a circuit, or a chip, a chip system, a module, or a control unit in the foregoing device or apparatus. This is not specifically limited in this application. It should be noted that, in this application, reference to the first communication apparatus may mean the first communication apparatus itself, or may mean a chip, a functional module, an integrated circuit, or the like that is in the first communication apparatus and that completes the method provided in this application. This is not specifically limited in this application. In the third aspect and possible implementations of the third aspect, the first communication apparatus is used as an example for description. The first communication apparatus includes:
a processing module, configured to determine N groups of capability information, where each of the N groups of capability information includes at least one of the following: a rated output power, a power back-off amount, an antenna gain, an output power density, a type of an antenna in the first communication apparatus, a maximum output power, a minimum output power, or an antenna capability level, and N is an integer greater than or equal to 1; and
a transceiver module, configured to send the N groups of capability information to a second communication apparatus.

A fourth aspect of this application provides a second communication apparatus. The second communication apparatus may be a device or an apparatus with a chip, or a device or an apparatus integrated with a circuit, or a chip, a chip system, a module, or a control unit in the foregoing device or apparatus. This is not specifically limited in this application. It should be noted that, in this application, reference to the second communication apparatus may mean the second communication apparatus itself, or may mean a chip, a functional module, an integrated circuit, or the like that is in the second communication apparatus and that completes the method provided in this application. This is not specifically limited in this application. In the fourth aspect and possible implementations of the fourth aspect, the second communication apparatus is used as an example for description. The second communication apparatus includes:
a transceiver module, configured to receive N groups of capability information from a first communication apparatus, where each of the N groups of capability information includes at least one of the following: a rated output power, a power back-off amount, an antenna gain, an output power density, a type of an antenna in the first communication apparatus, a maximum output power, a minimum output power, or an antenna capability level, and N is an integer greater than or equal to 1; and
a processing module, configured to communicate with the first communication apparatus based on the N groups of capability information.

Based on the third aspect or the fourth aspect, in a possible implementation, the first communication apparatus supports Nmax groups of capability information, where N is less than or equal to Nmax, and Nmax is an integer greater than or equal to 2.

Based on the third aspect or the fourth aspect, in a possible implementation, the N groups of capability information include N indexes, and each of the N indexes corresponds to one of the N groups of capability information.

Based on the third aspect or the fourth aspect, in a possible implementation, in the N groups of capability information, different groups of capability information differ in at least one of the following corresponding parameters, where the at least one parameter includes at least one of the following: a modulation scheme used by the terminal device, a modulation order used by the terminal device, a code rate used by the terminal device, spectral efficiency used by the terminal device, a waveform used by the terminal device, a polarization manner used by the first communication apparatus, a position of a time-frequency resource allocated to the first communication apparatus, a communication scenario of the first communication apparatus, or a motion status of the first communication apparatus.

Based on the third aspect or the fourth aspect, in a possible implementation, a maximum output power P_{CMAX,f,c} of the first communication apparatus satisfies the following condition:

$${P}_{CMAX \_ L , f , c} \leq {P}_{CMAX , f , c} \leq {P}_{CMAX \_ H , f , c}$$

$${P}_{CMAX \_ L , f , c} = min ( {P}_{EMAX , c} , {P}_{MOP \_ Low} , P 1 - {P}_{\_ {MPR}_{c}} ) ,$$

P_{CMAX_H,f,c}=min(P_{EMAX,c}, P_{MOP_High}), P_{EMAX,c} represents an upper limit value configured by the second communication apparatus for an output power of the first communication apparatus, a value of P_{EMAX,c} is in a range of [X, Y], X represents a minimum value of P_{EMAX,c}, Y represents a maximum value of P_{EMAX,c}, P_{MOP_Low} represents a minimum output power supported by the first communication apparatus, P_{MOP_High} represents a maximum output power supported by the first communication apparatus, P_{_MPR}_{_{c}} represents a maximum power back-off value supported by the first communication apparatus, and P1 is equal to P_{MOP_High} or is a maximum output power that is specified by the second communication apparatus and that is supported by a terminal type of the first communication apparatus.

Based on the third aspect or the fourth aspect, in a possible implementation, X is less than or equal to −30 dB, and Y is greater than 33 dB.

Based on the third aspect or the fourth aspect, in a possible implementation, X=−30 dB, and Y=64 dB.

Based on the third aspect or the fourth aspect, in a possible implementation, a minimum output power P_{CMIN,f,c} of the first communication apparatus satisfies the following condition:

$${P}_{CMIN , f , c} = P 2 - {P}_{\_ {MPR}_{c}}$$

P2 represents a rated output power of the first communication apparatus under a condition without power back-off, and P_{_MPR}_{_{c}} represents the maximum power back-off value supported by the first communication apparatus.

Based on the third aspect or the fourth aspect, in a possible implementation, a value of P2 is in a range of [a, b], a is greater than 23 dB and less than or equal to 31 dB, and b is greater than 31 dB.

Based on the third aspect or the fourth aspect, in a possible implementation, a=29 dB, and b=60 dB.

Based on the third aspect or the fourth aspect, in a possible implementation, the type of the antenna in the first communication apparatus includes one or more of the following: a parabolic antenna, a phased-array antenna, an omnidirectional antenna, a directional antenna, an active antenna, or a passive antenna.

A fifth aspect of this application provides a first communication apparatus. The first communication apparatus includes a processor. The processor is configured to invoke a computer program or computer instructions in a memory, to enable the processor to be configured to perform any one of the implementations of the first aspect or the second aspect.

Optionally, the communication apparatus further includes a transceiver. The processor is configured to control the transceiver to perform any one of the implementations of the first aspect or the second aspect.

Optionally, the processor is integrated with the memory.

A sixth aspect of this application provides a computer program product including computer instructions. When the computer program product is run on a computer, the computer is enabled to perform any one of the implementations of the first aspect or the second aspect.

A seventh aspect of this application provides a computer-readable storage medium, including computer instructions. When the computer instructions are run on a computer, the computer is enabled to perform any one of the implementations of the first aspect or the second aspect.

An eighth aspect of this application provides a chip apparatus, including a processor configured to invoke a computer program or computer instructions in a memory, to enable the processor to perform any one of the implementations of the first aspect or the second aspect.

Optionally, the processor is coupled to the memory through an interface.

A ninth aspect of this application provides a communication system. The communication system includes a terminal device and a network device. The terminal device is configured to perform the method according to the first aspect, and the network device is configured to perform the method according to the second aspect.

A tenth aspect of this application provides a communication apparatus. The communication apparatus includes a logic circuit and an input/output interface. The logic circuit is configured to perform the processing operation according to the first aspect, and the input/output interface is configured to perform the receiving and sending operations according to the first aspect. Alternatively, the logic circuit is configured to perform the processing operation according to the second aspect, and the input/output interface is configured to perform the receiving and sending operations according to the second aspect.

It can be learned from the foregoing technical solutions that embodiments of this application have the following advantages.

It can be learned from the foregoing technical solutions that the terminal device supports the N groups of capability information, where N is an integer greater than or equal to 1. The terminal device may report the N groups of capability information to the network device, where each of the N groups of capability information includes at least one of the following: the rated output power, the power back-off amount, the antenna gain, the output power density, the type of the antenna in the terminal device, the maximum output power, the minimum output power, or the antenna capability level, so that the network device communicates with the terminal device based on the N groups of capability information. For example, the terminal device may be a terminal with an ultra-high capability, and the terminal with an ultra-high capability may report the N groups of capability information supported by the terminal, so that the network device communicates with the terminal with an ultra-high capability. For example, the network device performs power control and/or service type selection on the terminal with an ultra-high capability based on the N groups of capability information.

### BRIEF DESCRIPTION OF DRAWINGS

FIG. 1 is a diagram of a communication system according to an embodiment of this application;

FIG. 2 is another diagram of a communication system according to an embodiment of this application;

FIG. 3 is still another diagram of a communication system according to an embodiment of this application;

FIG. 4 is a diagram of an embodiment of a capability information reporting method and a communication method according to an embodiment of this application;

FIG. 5 is a diagram of a structure of a communication apparatus according to an embodiment of this application;

FIG. 6 is a diagram of another structure of a communication apparatus according to an embodiment of this application;

FIG. 7 is a diagram of still another structure of a communication apparatus according to an embodiment of this application;

FIG. 8 is a diagram of a structure of a terminal device according to an embodiment of this application; and

FIG. 9 is a diagram of a structure of a network device according to an embodiment of this application.

### DESCRIPTION OF EMBODIMENTS

Embodiments of this application provide a capability information reporting method, a communication method, and a related apparatus for a terminal device to report N groups of capability information to a network device, so that the network device communicates with the terminal device.

Reference to “an embodiment”, “some embodiments”, or the like described in this specification indicates that one or more embodiments of this application include a specific feature, structure, or characteristic described with reference to embodiments. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner. The terms “include”, “have”, and their variants all mean “include but are not limited to”, unless otherwise specifically emphasized.

In this application, “at least one” means one or more, and “a plurality of” means two or more. The term “and/or” is an association relationship for describing associated objects and represents that three relationships may exist. For example, A and/or B may represent the following three cases: Only A exists, both A and B exist, and only B exists. A and B may be singular or plural. “At least one of the following items (pieces)” or a similar expression thereof means any combination of these items, including a singular item (piece) or any combination of plural items (pieces). For example, at least one of a, b, or c may represent a, b, c, a and b, a and c, b and c, or a, b, and c, where a, b, and c may be singular or plural.

Technical solutions of this application may be applied to a terrestrial network system, or may be applied to a non-terrestrial network (non-terrestrial network, NTN) system.

The terrestrial network system may include a cellular communication system, an internet of things communication system, an internet of vehicles communication system, a device to device (device to device, D2D) communication system, a mobile communication system, or the like. The mobile communication system may be a 4th generation (4th generation, 4G) communication system, a worldwide interoperability for microwave access (worldwide interoperability for microwave access, WiMAX) communication system, a 5G communication system, a future mobile communication system, or the like. For example, the 4G communication system may be a long term evolution (long term evolution, LTE) system, and the 5G communication system may be a new radio (new radio, NR) system.

The non-terrestrial network system may include a satellite communication system and a high-altitude platform station (high-altitude platform station, HAPS) communication system, for example, an integrated communication and navigation (integrated communication and navigation, IcaN) system, a global navigation satellite system (global navigation satellite system, GNSS), and an ultra-dense low-orbit satellite communication system. The satellite communication system may be integrated with a conventional mobile communication system.

With reference to FIG. 1 to FIG. 3, the following describes some possible communication scenarios to which this application is applicable. This application is still applicable to another communication scenario, and the following example does not constitute a limitation on this application.

FIG. 1 is a diagram of a communication system according to an embodiment of this application. Refer to FIG. 1. In the communication system, a terminal device on the ground establishes a communication connection to a base station through a satellite, so that the terminal device accesses a network.

The base station may be deployed on the ground, the satellite is connected to a ground station through a radio link, and the base station is connected to the ground station. The ground station and the terrestrial base station are connected to a core network in a wired or wireless manner. The satellite acts as a forwarding role (that is, the satellite has only a transparent transmission and forwarding function), and is configured to forward signaling and data between the terminal device and the base station. The base station mainly provides a radio access service, schedules a radio resource to an access terminal device, and provides a reliable radio transmission protocol, a data encryption protocol, and the like. The ground station is responsible for forwarding signaling and data between the terminal device and the base station, and forwarding signaling and data between the terminal device and the core network.

In the communication system shown in FIG. 1, the core network provides services such as user access control, mobility management, session management, user security authentication, and charging. The core network includes a plurality of functional units, and may be specifically divided into a control-plane functional entity and a data-plane functional entity. For example, the control-plane functional entity includes an access and mobility management function (access and mobility management function, AMF) and a session management function (session management function, SMF). The AMF is responsible for user access management, security authentication, mobility management, and the like. The data-plane functional entity includes a user plane function (user plane function, UPF). The UPF is responsible for managing functions such as user plane data transmission and traffic statistics collection.

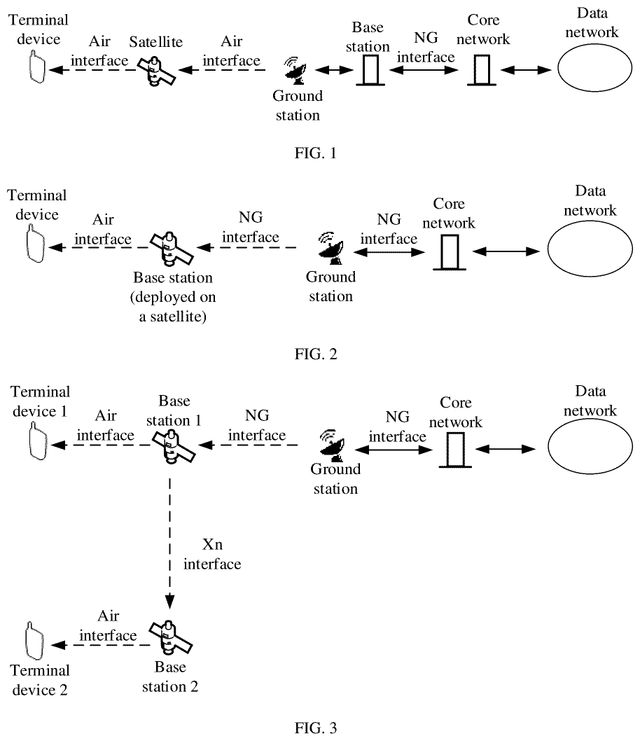

FIG. 2 is another diagram of a communication system according to an embodiment of this application. Refer to FIG. 2. In the communication system, some or all functions of a base station are deployed on a satellite. A terminal device on the ground establishes a communication connection to the base station, so that a terminal device accesses a network. Signaling and data exchange are completed between the base station and the terminal device. The base station is connected to a core network via a ground station, and the ground station is connected to the core network in a wired or wireless manner.

In the communication system shown in FIG. 2, the core network includes a plurality of functional units, and may be specifically divided into a control-plane functional entity and a data-plane functional entity. For example, the control-plane functional entity includes an AMF and an SMF. The data-plane functional entity includes a UPF. For function descriptions of these functional entities, refer to the foregoing related descriptions. Details are not described herein again.

FIG. 3 is still another diagram of a communication system according to an embodiment of this application. Refer to FIG. 3. The communication system shown in FIG. 3 is similar to the communication system shown in FIG. 2. As shown in FIG. 3, the communication system includes a base station 1, a base station 2, a terminal device 1, and a terminal device 2. The base station 1 is deployed on a satellite, and the base station 2 is deployed on a satellite. The base station 1 and the base station 2 may be connected through an Xn interface, and signaling exchange and user data transmission may be performed between the base station 1 and the base station 2.

In the communication systems shown in FIG. 1 to FIG. 3, that N groups of capability information supported by the terminal device are reported to the base station can be implemented between the terminal device and the base station by performing the technical solutions in this application, so that the base station communicates with the terminal device.

The communication system to which this application is applicable includes the terminal device and a network device. If some functions of the network device are deployed on a satellite, the network device may also be referred to as a satellite. If the network device and the satellite are separately deployed, the satellite is configured to forward signaling, data, and the like between the terminal device and the network device.

The following describes some possible forms of the terminal device and the network device.

The terminal device may be a device that provides voice or data connectivity for a user. The terminal device is also referred to as user equipment (user equipment, UE), or may be referred to as a mobile station (mobile station), a subscriber unit (subscriber unit), a station (station), terminal equipment (terminal equipment, TE), customer premises equipment (customer premise equipment, CPE), a mobile terminal (mobile terminal, MT), or the like. The terminal device is a device that includes a wireless communication function (providing voice/data connectivity for the user), for example, a handheld device having a wireless connection function, a vehicle-mounted device, or a machine-type communication (machine-type communication, MTC) terminal.

Currently, the terminal device may include a mobile phone (mobile phone), a cellular phone (phone), a tablet computer (pad), a notebook computer, a personal digital assistant (personal digital assistant, PDA), a wireless modem (modem), a cordless phone (cordless phone), a palmtop computer, a mobile internet device (mobile internet device, MID), a wireless local loop (wireless local loop, WLL) station, a wearable device, a computing device, a virtual reality (virtual reality, VR) device, an augmented reality (augmented reality, AR) device, an internet of things (internet of things, IoT) device, a wireless terminal in industrial control (industrial control), a wireless terminal (such as an unmanned aerial vehicle and a vehicle) in self driving (self driving), a wireless terminal in remote medical surgery (remote medical surgery), a wireless terminal in a smart grid (smart grid), a wireless terminal in transportation safety (transportation safety), a wireless terminal in a smart city (smart city), a terminal device and a vehicle in smart transportation, a household device in a smart household, an electricity meter reading instrument in a smart grid, a voltage monitoring instrument, an environment monitoring instrument, a video surveillance instrument in a smart security network, a cash register, or a wireless terminal in a smart home (smart home). For example, the wireless terminal in the self driving may be an unmanned aerial vehicle, a helicopter, or an airplane. For example, a wireless terminal in an internet of vehicles may be a vehicle-mounted device, an entire vehicle device, a vehicle-mounted module, a vehicle, or a ship. The wireless terminal in industrial control may be a camera, a robot, a robotic arm, or the like. The wireless terminal in the smart home may be a television, an air conditioner, a sweeper, a sound box, a set-top box, or the like.

The terminal device may be a mobile terminal or a non-mobile terminal, or may be an airborne terminal, a handheld terminal, or the like. In this application, optionally, the terminal device is not limited by factors such as a size and power supply, and the terminal device may transmit a high power. The terminal device may have one or more sets of antennas. When the terminal device has a plurality of sets of antennas, different sets of antennas in the plurality of sets of antennas have different antenna capabilities, or different sets of antennas correspond to different antenna gains. The antenna gain of the antenna in the terminal device may be greater than or equal to 0.

It should be noted that the terminal device may be a device or an apparatus with a chip, a device or an apparatus integrated with a circuit, or a chip, a chip system, a module, or a control unit in the foregoing device or apparatus. This is not specifically limited in this application. It should be noted that, in this application, reference to the terminal device may mean the terminal device itself, or may mean a chip, a functional module, an integrated circuit, or the like that is in the terminal device and that completes the method provided in this application. This is not specifically limited in this application.

The network device supports access by the terminal device and provides functions such as a communication service for the terminal device. For example, the network device may be a terrestrial device like an evolved NodeB (evolved NodeB, eNB) in a 4G access technology communication system, a next generation NodeB (next generation NodeB, gNB) in a 5G access technology communication system, a transmission reception point (transmission reception point, TRP), a relay node (relay node), an access point (access point, AP), or a gateway (gateway). For example, the gateway is used for communication between the terminal device and a core network, for example, a ground station. Alternatively, the network device may be a non-terrestrial device: a satellite base station, a satellite ground station, or a high-altitude base station. For example, the network device may be a device, such as a hot air balloon, that may provide a wireless access function for the terminal device, a low-orbit satellite, a medium-orbit satellite, or a high-orbit satellite, or may be an unmanned aerial vehicle or an airplane, or may be a mobile switching center or a device that undertakes a base station function in device-to-device (device-to-device, D2D), vehicle-to-everything (vehicle-to-everything, V2X), or machine-to-machine (machine, M2M) communication.

It should be noted that the network device may be a device or an apparatus with a chip, a device or an apparatus integrated with a circuit, or a chip, a chip system, a module, or a control unit in the foregoing device or apparatus. This is not specifically limited in this application. It should be noted that, in this application, reference to the network device may mean the network device itself, or may mean a chip, a functional module, an integrated circuit, or the like that is in the network device and that completes the method provided in this application. This is not specifically limited in this application.

Compared with terrestrial communication, non-terrestrial communication has unique advantages. For example, non-terrestrial communication may provide a wider coverage area. The non-terrestrial communication may be satellite communication, high-altitude platform station communication, or the like. Non-terrestrial network devices are not vulnerable to damage from natural disasters or external forces. Non-terrestrial communication is introduced into a 5G communication system, so that a communication service can be provided for some areas that cannot be covered by a terrestrial communication network, such as the ocean or a forest, and reliability of the 5G communication system can be further enhanced. For example, it is ensured that aircrafts, trains, and users on these transportation vehicles receive higher-quality communication services, and more data transmission resources are provided for 5G communication to improve a network speed. Therefore, supporting both terrestrial communication and non-terrestrial communication is an inevitable trend of a future 5G communication system, and has benefits in terms of wide coverage, reliability, multi-connectivity, a high throughput, and the like.

Currently, satellite communication has been introduced into a 3GPP standard, and is used as a communication scenario of 5G communication. In the 3GPP standard, to adapt to features of a high delay and high mobility, a timing technology, a synchronization technology, a HARQ technology, and other technologies are correspondingly enhanced. Due to long distances in satellite communication, in addition to conventional terminals, terminals with ultra-high capabilities need to be defined to improve communication quality. The terminal with an ultra-high capability is not affected by a size and power supply, and may transmit a high output power. Therefore, an output power architecture for the conventional terminal is not applicable to the terminal with an ultra-high capability. Therefore, how the network device needs to communicate with the terminal with an ultra-high capability is a problem worth considering. Herein, satellite communication is mainly used as an example to describe the problem to be resolved in this application. Certainly, this application is also applicable to another non-terrestrial network. This is not specifically limited in this application.

The terminal with an ultra-high capability is usually a fixed ground-based terminal, a vehicle-mounted mobile terminal, an airborne terminal, a shipborne terminal, or the like. An operating frequency range of the terminal with an ultra-high capability may be in a low frequency band. For example, in a 5G protocol, frequency bands in a frequency range (frequency range, FR1) range from 410 MHz to 7125 MHz (megahertz), and frequency bands in an FR2 range from 24250 MHz to 52600 MHz. Compared with the frequency bands in the FR2, the frequency bands in the FR1 is low frequency bands.

This application provides the corresponding technical solutions for the terminal device to report the N groups of capability information to the network device, so that the network device communicates with the terminal device. For example, the terminal device is a terminal with an ultra-high capability, so that the network device communicates with the terminal with an ultra-high capability.

The following describes the technical solutions in this application with reference to specific embodiments.

FIG. 4 is a diagram of an embodiment of a capability information reporting method and a communication method according to an embodiment of this application. Refer to FIG. 4. The method includes the following steps.

401: The terminal device determines N groups of capability information.

Each of the N groups of capability information includes at least one of the following: a rated output power, a power back-off amount, an antenna gain, an output power density, a type of an antenna in the terminal device, a maximum output power, a minimum output power, or an antenna capability level. N is an integer greater than or equal to 1. Optionally, the rated output power is equal to an output power density multiplied by a bandwidth of the terminal device.

In this application, optionally, the terminal device supports Nmax groups of capability information. N is less than or equal to Nmax, and Nmax is an integer greater than or equal to 2. In other words, the terminal device supports two or more groups of capability information.

It should be noted that the terminal device may support only one power back-off amount. In this implementation, the terminal device supports one group of capability information, and the group of capability information includes the power back-off amount of the terminal device.

In this application, the terminal device is a terminal with an ultra-high capability, and a size, power supply, and the like of the terminal device are not limited. Therefore, compared with a conventional terminal, the terminal device can support a higher transmit power. For example, a maximum output power supported by the terminal device under a condition without power back-off is greater than 31 dB.

Optionally, in the N groups of capability information, different groups of capability information differ in at least one of the following corresponding parameters. The at least one parameter includes at least one of the following: a modulation scheme used by the terminal device, a modulation order used by the terminal device, a code rate used by the terminal device, spectral efficiency used by the terminal device, a waveform used by the terminal device, or a polarization manner used by the terminal device, a position of a time-frequency resource allocated to the terminal device, a communication scenario of the terminal device, or a motion status of the terminal device.

Optionally, the modulation scheme includes quadrature phase shift keying (quadrature phase shift keying, QPSK), binary phase shift keying (binary phase shift keying, BPSK), 16 quadrature amplitude modulation (16 quadrature amplitude modulation, 16QAM), 64QAM, or 256QAM.

Optionally, the waveform includes discrete fourier transform spread orthogonal frequency division multiplexing (discrete fourier transform spread orthogonal frequency division multiplexing, DFT-s-OFDM), or cyclic prefix orthogonal frequency division multiplexing (cyclic prefix orthogonal frequency division multiplexing, CP-OFDM).

Optionally, the polarization manner includes horizontal polarization, vertical polarization, left-hand polarization, or right-hand polarization.

Optionally, the communication scenario includes a high-orbit satellite communication scenario or a non-high-orbit satellite communication scenario.

Optionally, the motion status includes a high-speed motion state or a low-speed motion state.

It can be learned from the foregoing that each group of capability information may correspond to one working condition, and the working condition may include at least one of the foregoing at least one parameter. The terminal device supports different capabilities under different working conditions. For example, if the terminal device uses different modulation schemes, the capability information supported by the terminal device is different.

Optionally, the terminal device reports, based on the communication scenario of the terminal device, the N groups of capability information supported by the terminal device in the communication scenario. For example, the terminal device determines, based on broadcast information delivered by the network device, that the terminal device is in the high-orbit satellite communication scenario. The terminal device may communicate with the network device by using a higher output power and an antenna with a stronger capability. Therefore, the terminal device may report corresponding capability information, so that the terminal device communicates with the network device in the high-orbit satellite communication scenario.

Optionally, the terminal device reports, based on the motion status of the terminal device, the N groups of capability information supported by the terminal device. For example, when the terminal device is in the high-speed motion state, the terminal device may communicate with the network device by using a higher output power and an antenna with a stronger capability. Therefore, the terminal device reports related capability information such as the higher output power and the antenna with a stronger capability. For another example, the terminal device is in the low-speed motion state, and the terminal device may communicate with the network device by using a low output power and a common antenna. Therefore, the terminal device reports related capability information such as the low output power and the common antenna.

Optionally, the type of the antenna in the terminal device includes one or more of the following: a parabolic antenna, a phased-array antenna, an omnidirectional antenna, a directional antenna, an active antenna, or a passive antenna.

Optionally, an antenna capability of the terminal device may be classified into one or more antenna capability levels. Each antenna capability level corresponds to one antenna gain, and different antenna capability levels may correspond to different antenna gains. For example, if the terminal device has only one type of antenna, the terminal device may have only one antenna capability level. For another example, if the terminal device includes a plurality of types of antennas, each type of antenna in the plurality of types of antennas has a corresponding antenna gain. Each type of antenna in the plurality of types of antennas corresponds to one antenna capability level. For example, in a working condition, the terminal device may select a corresponding antenna to communicate with the network device. A corresponding group of capability information under the working condition includes an antenna capability level corresponding to the antenna.

Optionally, each group of capability information further includes an antenna scanning manner, for example, mechanical scanning or electrical scanning.

It should be noted that, optionally, the N groups of capability information are a part of or all of all groups of capability information supported by the terminal device.

Optionally, an antenna gain in each of the N groups of capability information may be greater than or equal to 0.

The following describes some possible implementations of each of the N groups of capability information.

Implementation 1: Each of the N groups of capability information includes the rated output power.

For example, the following shows a possible implementation of the N groups of capability information with reference to Table 1.

TABLE 1

| | Each group of |
|---|---|
| | capability |
| Working condition | information |
| The terminal device uses the QPSK modulation | Rated output |
| scheme and the DFT-s-OFDM waveform | power 1 |
| The terminal device uses the BPSK modulation | Rated output |
| scheme and the DFT-s-OFDM waveform | power 2 |
| The terminal device uses the 16QAM modulation | Rated output |
| scheme and the DFT-s-OFDM waveform | power 3 |
| The terminal device uses the 64QAM modulation | Rated output |
| scheme and the DFT-s-OFDM waveform | power 4 |
| The terminal device uses the 256QAM modulation | Rated output |
| scheme and the DFT-s-OFDM waveform | power 5 |
| The terminal device uses the QPSK modulation | Rated output |
| scheme and the CP-OFDM waveform | power 6 |
| The terminal device uses the BPSK modulation | Rated output |
| scheme and the CP-OFDM waveform | power 7 |
| The terminal device uses the 16QAM modulation | Rated output |
| scheme and the CP-OFDM waveform | power 8 |
| The terminal device uses the 64QAM modulation | Rated output |
| scheme and the CP-OFDM waveform | power 9 |
| The terminal device uses the 256QAM modulation | Rated output |
| scheme and the CP-OFDM waveform | power 10 |

In Table 1, the working condition includes the modulation scheme and the waveform that are used by the terminal device. It can be learned from Table 1 that rated output powers of the terminal device are different under different working conditions. In other words, the terminal device supports different rated output powers for different modulation schemes and/or different waveforms. For example, when the terminal device uses the QPSK modulation scheme and the DFT-s-OFDM waveform, the terminal device supports the rated output power 1. In other words, a first group of capability information of the terminal device includes the rated output power 1. When the terminal device uses the BPSK modulation scheme and the DFT-s-OFDM waveform, the terminal device supports the rated output power 2. In other words, a second group of capability information of the terminal device includes the rated output power 2. When the terminal device uses the 16QAM modulation scheme and the DFT-s-OFDM waveform, the terminal device supports the rated output power 3. In other words, a third group of capability information of the terminal device includes the rated output power 3. When the terminal device uses the 64QAM modulation scheme and the DFT-s-OFDM waveform, the terminal device supports the rated output power 4. In other words, a fourth group of capability information of the terminal device includes the rated output power 4. When the terminal device uses the 256QAM modulation scheme and the DFT-s-OFDM waveform, the terminal device supports the rated output power 5. In other words, a fifth group of capability information of the terminal device includes the rated output power 5. When the terminal device uses the QPSK modulation scheme and the CP-OFDM waveform, the terminal device supports the rated output power 6. In other words, a sixth group of capability information of the terminal device includes the rated output power 6. When the terminal device uses the BPSK modulation scheme and the CP-OFDM waveform, the terminal device supports the rated output power 7. In other words, a seventh group of capability information of the terminal device includes the rated output power 7. When the terminal device uses the 16QAM modulation scheme and the CP-OFDM waveform, the terminal device supports the rated output power 8. In other words, an eighth group of capability information of the terminal device includes the rated output power 8. When the terminal device uses the 64QAM modulation scheme and the CP-OFDM waveform, the terminal device supports the rated output power 9. In other words, a ninth group of capability information of the terminal device includes the rated output power 9. When the terminal device uses the 256QAM modulation scheme and the CP-OFDM waveform, the terminal device supports the rated output power 10. In other words, a tenth group of capability information of the terminal device includes the rated output power 10. In Table 1, under ten working conditions, the terminal device may determine ten groups of capability information, and each group of capability information includes a rated output power of the terminal device under a corresponding working condition. The terminal device may report the ten groups of capability information to the network device.

Implementation 2: Each of the N groups of capability information includes the power back-off amount.

For example, the following shows another possible implementation of the N groups of capability information with reference to Table 2.

TABLE 2

| | Each group of |
|---|---|
| | capability |
| Working condition | information |
| The terminal device uses the QPSK modulation | Power back-off |
| scheme and the DFT-s-OFDM waveform | amount 1 |
| The terminal device uses the BPSK modulation | Power back-off |
| scheme and the DFT-s-OFDM waveform | amount 2 |
| The terminal device uses the 16QAM modulation | Power back-off |
| scheme and the DFT-s-OFDM waveform | amount 3 |
| The terminal device uses the 64QAM modulation | Power back-off |
| scheme and the DFT-s-OFDM waveform | amount 4 |
| The terminal device uses the 256QAM modulation | Power back-off |
| scheme and the DFT-s-OFDM waveform | amount 5 |
| The terminal device uses the QPSK modulation | Power back-off |
| scheme and the CP-OFDM waveform | amount 6 |
| The terminal device uses the BPSK modulation | Power back-off |
| scheme and the CP-OFDM waveform | amount 7 |
| The terminal device uses the 16QAM modulation | Power back-off |
| scheme and the CP-OFDM waveform | amount 8 |
| The terminal device uses the 64QAM modulation | Power back-off |
| scheme and the CP-OFDM waveform | amount 9 |
| The terminal device uses the 256QAM modulation | Power back-off |
| scheme and the CP-OFDM waveform | amount 10 |

In Table 2, the working condition includes the modulation scheme and the waveform that are used by the terminal device. It can be learned from Table 2 that power back-off amounts of the terminal device are different under different working conditions. In other words, the terminal device supports different power back-off amounts for different modulation schemes and/or different waveforms. For example, when the terminal device uses the QPSK modulation scheme and the DFT-s-OFDM waveform, the terminal device supports the power back-off amount 1. In other words, a first group of capability information of the terminal device includes the power back-off amount 1. When the terminal device uses the BPSK modulation scheme and the DFT-s-OFDM waveform, the terminal device supports the power back-off amount 2. In other words, a second group of capability information of the terminal device includes the power back-off amount 2. When the terminal device uses the 16QAM modulation scheme and the DFT-s-OFDM waveform, the terminal device supports the power back-off amount 3. In other words, a third group of capability information of the terminal device includes the power back-off amount 3. When the terminal device uses the 64QAM modulation scheme and the DFT-s-OFDM waveform, the terminal device supports the power back-off amount 4. In other words, a fourth group of capability information of the terminal device includes the power back-off amount 4. When the terminal device uses the 256QAM modulation scheme and the DFT-s-OFDM waveform, the terminal device supports the power back-off amount 5. In other words, a fifth group of capability information of the terminal device includes the power back-off amount 5. When the terminal device uses the QPSK modulation scheme and the CP-OFDM waveform, the terminal device supports the power back-off amount 6. In other words, a sixth group of capability information of the terminal device includes the power back-off amount 6. When the terminal device uses the BPSK modulation scheme and the CP-OFDM waveform, the terminal device supports the power back-off amount 7. In other words, a seventh group of capability information of the terminal device includes the power back-off amount 7. When the terminal device uses the 16QAM modulation scheme and the CP-OFDM waveform, the terminal device supports the power back-off amount 8. In other words, an eighth group of capability information of the terminal device includes the power back-off amount 8. When the terminal device uses the 64QAM modulation scheme and the CP-OFDM waveform, the terminal device supports the power back-off amount 9. In other words, a ninth group of capability information of the terminal device includes the power back-off amount 9. When the terminal device uses the 256QAM modulation scheme and the CP-OFDM waveform, the terminal device supports the power back-off amount 10. In other words, a tenth group of capability information of the terminal device includes the power back-off amount 10. In Table 2, under ten working conditions, the terminal device may determine ten groups of capability information, and each group of capability information includes a power back-off amount of the terminal device under a corresponding working condition. The terminal device may report the ten groups of capability information to the network device.

In the implementation 2, optionally, each of the N groups of capability information further includes a rated output power of the terminal device under the condition without power back-off. For example, the rated output power is in a range of [a, b]. Optionally, a unit corresponding to a and b is dB. For example, a is greater than 23 dB and less than or equal to 31 dB, and b is greater than 31 dB. For example, the rated output power is in a range of [29 dB, 60 dB].

It can be learned that each group of capability information includes the rated output power of the terminal device under the condition without power back-off and the power back-off amount of the terminal device under the corresponding working condition.

Implementation 3: Each of the N groups of capability information includes the maximum output power and the minimum output power.

The following shows still another possible implementation of the N groups of capability information with reference to Table 3.

TABLE 3

| | Each group of |
|---|---|
| | capability |
| Working condition | information |
| The terminal device uses the QPSK | Maximum output power |
| modulation scheme and the | 1 and minimum |
| DFT-s-OFDM waveform | output power 1 |
| The terminal device uses the BPSK | Maximum output power |
| modulation scheme and the | 2 and minimum |
| DFT-s-OFDM waveform | output power 2 |
| The terminal device uses the 16QAM | Maximum output power |
| modulation scheme and the | 3 and minimum |
| DFT-s-OFDM waveform | output power 3 |
| The terminal device uses the 64QAM | Maximum output power |
| modulation scheme and the | 4 and minimum |
| DFT-s-OFDM waveform | output power 4 |
| The terminal device uses the 256QAM | Maximum output power |
| modulation scheme and the | 5 and minimum |
| DFT-s-OFDM waveform | output power 5 |
| The terminal device uses the QPSK | Maximum output power |
| modulation scheme and the CP-OFDM | 6 and minimum |
| waveform | output power 6 |
| The terminal device uses the BPSK | Maximum output power |
| modulation scheme and the CP-OFDM | 7 and minimum |
| waveform | output power 7 |
| The terminal device uses the 16QAM | Maximum output power |
| modulation scheme and the CP-OFDM | 8 and minimum |
| waveform | output power 8 |
| The terminal device uses the 64QAM | Maximum output power |
| modulation scheme and the CP-OFDM | 9 and minimum |
| waveform | output power 9 |
| The terminal device uses the 256QAM | Maximum output power |
| modulation scheme and the CP-OFDM | 10 and minimum |
| waveform | output power 10 |

In Table 3, the working condition includes the modulation scheme and the waveform that are used by the terminal device. It can be learned from Table 3 that the terminal device may support different maximum output powers and different minimum output powers under different working conditions. In other words, the terminal device supports different maximum output powers and different minimum output powers for different modulation schemes and/or different waveforms. For example, when the terminal device uses the QPSK modulation scheme and the DFT-s-OFDM waveform, the terminal device supports the maximum output power 1 and the minimum output power 1. In other words, a first group of capability information of the terminal device includes the maximum output power 1 and the minimum output power 1. When the terminal device uses the BPSK modulation scheme and the DFT-s-OFDM waveform, the terminal device supports the maximum output power 2 and the minimum output power 2. In other words, a second group of capability information of the terminal device includes the maximum output power 2 and the minimum output power 2. When the terminal device uses the 16QAM modulation scheme and the DFT-s-OFDM waveform, the terminal device supports the maximum output power 3 and the minimum output power 3. In other words, a third group of capability information of the terminal device includes the maximum output power 3 and the minimum output power 3. When the terminal device uses the 64QAM modulation scheme and the DFT-s-OFDM waveform, the terminal device supports the maximum output power 4 and the minimum output power 4. In other words, a fourth group of capability information of the terminal device includes the maximum output power 4 and the minimum output power 4. When the terminal device uses the 256QAM modulation scheme and the DFT-s-OFDM waveform, the terminal device supports the maximum output power 5 and the minimum output power 5. In other words, a fifth group of capability information of the terminal device includes the maximum output power 5 and the minimum output power 5.

When the terminal device uses the QPSK modulation scheme and the CP-OFDM waveform, the terminal device supports the maximum output power 6 and the minimum output power 6. In other words, a sixth group of capability information of the terminal device includes the maximum output power 6 and the minimum output power 6. When the terminal device uses the BPSK modulation scheme and the CP-OFDM waveform, the terminal device supports the maximum output power 7 and the minimum output power 7. In other words, a seventh group of capability information of the terminal device includes the maximum output power 7 and the minimum output power 7. When the terminal device uses the 16QAM modulation scheme and the CP-OFDM waveform, the terminal device supports the maximum output power 8 and the minimum output power 8. In other words, an eighth group of capability information of the terminal device includes the maximum output power 8 and the minimum output power 8. When the terminal device uses the 64QAM modulation scheme and the CP-OFDM waveform, the terminal device supports the maximum output power 9 and the minimum output power 9. In other words, a ninth group of capability information of the terminal device includes the maximum output power 9 and the minimum output power 9. When the terminal device uses the 256QAM modulation scheme and the CP-OFDM waveform, the terminal device supports the maximum output power 10 and the minimum output power 10. In other words, a tenth group of capability information of the terminal device includes the maximum output power 10 and the minimum output power 10.

In Table 3, under ten working conditions, the terminal device may determine ten groups of capability information, and each group of capability information includes a maximum output power and a minimum output power that are supported by the terminal device under a corresponding working condition. Therefore, the terminal device may report the ten groups of capability information to the network device.

Implementation 4: Each of the N groups of capability information includes the maximum output power and the power back-off amount.

For example, the following shows still another possible implementation of the N groups of capability information with reference to Table 4.

TABLE 4

| | Each group of |
|---|---|
| | capability |
| Working condition | information |
| The terminal device uses the QPSK | Maximum output power |
| modulation scheme and the | 1 and power back-off |
| DFT-s-OFDM waveform | amount 1 |
| The terminal device uses the BPSK | Maximum output power |
| modulation scheme and the | 2 and power back-off |
| DFT-s-OFDM waveform | amount 2 |
| The terminal device uses the 16QAM | Maximum output power |
| modulation scheme and the | 3 and power back-off |
| DFT-s-OFDM waveform | amount 3 |
| The terminal device uses the 64QAM | Maximum output power |
| modulation scheme and the | 4 and power back-off |
| DFT-s-OFDM waveform | amount 4 |
| The terminal device uses the 256QAM | Maximum output power |
| modulation scheme and the | 5 and power back-off |
| DFT-s-OFDM waveform | amount 5 |
| The terminal device uses the QPSK | Maximum output power |
| modulation scheme and the CP-OFDM | 6 and power back-off |
| waveform | amount 6 |
| The terminal device uses the BPSK | Maximum output power |
| modulation scheme and the CP-OFDM | 7 and power back-off |
| waveform | amount 7 |
| The terminal device uses the 16QAM | Maximum output power |
| modulation scheme and the CP-OFDM | 8 and power back-off |
| waveform | amount 8 |
| The terminal device uses the 64QAM | Maximum output power |
| modulation scheme and the CP-OFDM | 9 and power back-off |
| waveform | amount 9 |
| The terminal device uses the 256QAM | Maximum output power |
| modulation scheme and the CP-OFDM | 10 and power back-off |
| waveform | amount 10 |

In Table 4, the working condition includes the modulation scheme and the waveform that are used by the terminal device. It can be learned from Table 4 that the terminal device may support different maximum output powers and different power back-off amounts under different working conditions. In other words, the terminal device supports different maximum output powers and different power back-off amounts for different modulation schemes and/or different waveforms. For example, when the terminal device uses the QPSK modulation scheme and the DFT-s-OFDM waveform, the terminal device supports the maximum output power 1 and the power back-off amount 1. In other words, a first group of capability information of the terminal device includes the maximum output power 1 and the power back-off amount 1. When the terminal device uses the BPSK modulation scheme and the DFT-s-OFDM waveform, the terminal device supports the maximum output power 2 and the power back-off amount 2. In other words, a second group of capability information of the terminal device includes the maximum output power 2 and the power back-off amount 2. When the terminal device uses the 16QAM modulation scheme and the DFT-s-OFDM waveform, the terminal device supports the maximum output power 3 and the power back-off amount 3. In other words, a third group of capability information of the terminal device includes the maximum output power 3 and the power back-off amount 3. When the terminal device uses the 64QAM modulation scheme and the DFT-s-OFDM waveform, the terminal device supports the maximum output power 4 and the power back-off amount 4. In other words, a fourth group of capability information of the terminal device includes the maximum output power 4 and the power back-off amount 4. When the terminal device uses the 256QAM modulation scheme and the DFT-s-OFDM waveform, the terminal device supports the maximum output power 5 and the power back-off amount 5. In other words, a fifth group of capability information of the terminal device includes the maximum output power 5 and the power back-off amount 5.

When the terminal device uses the QPSK modulation scheme and the CP-OFDM waveform, the terminal device supports the maximum output power 6 and the power back-off amount 6. In other words, a sixth group of capability information of the terminal device includes the maximum output power 6 and the power back-off amount 6. When the terminal device uses the BPSK modulation scheme and the CP-OFDM waveform, the terminal device supports the maximum output power 7 and the power back-off amount 7. In other words, a seventh group of capability information of the terminal device includes the maximum output power 7 and the power back-off amount 7. When the terminal device uses the 16QAM modulation scheme and the CP-OFDM waveform, the terminal device supports the maximum output power 8 and the power back-off amount 8. In other words, an eighth group of capability information of the terminal device includes the maximum output power 8 and the power back-off amount 8. When the terminal device uses the 64QAM modulation scheme and the CP-OFDM waveform, the terminal device supports the maximum output power 9 and the power back-off amount 9. In other words, a ninth group of capability information of the terminal device includes the maximum output power 9 and the power back-off amount 9. When the terminal device uses the 256QAM modulation scheme and the CP-OFDM waveform, the terminal device supports the maximum output power 10 and the power back-off amount 10. In other words, a tenth group of capability information of the terminal device includes the maximum output power 10 and the power back-off amount 10.

In Table 4, under ten working conditions, the terminal device may determine ten groups of capability information. Each group of capability information includes a maximum output power and a power back-off amount that are supported by the terminal device under a corresponding working condition. The terminal device may report the ten groups of capability information to the network device.

Optionally, in the foregoing implementation 1 to implementation 3, each group of capability information further includes the antenna capability level or the antenna gain.

For example, Table 5 shows still another possible implementation of the N groups of capability information.

TABLE 5

| Working condition | Each group of capability information |
|---|---|
| The terminal device uses the QPSK modulation | Maximum output power 1, power back-off |
| scheme and the DFT-s-OFDM waveform | amount 1, and antenna capability level 1 |
| The terminal device uses the BPSK modulation | Maximum output power 2, power back-off |
| scheme and the DFT-s-OFDM waveform | amount 2, and antenna capability level 2 |
| The terminal device uses the 16QAM modulation | Maximum output power 3, power back-off |
| scheme and the DFT-s-OFDM waveform | amount 3, and antenna capability level 3 |
| The terminal device uses the 64QAM modulation | Maximum output power 4, power back-off |
| scheme and the DFT-s-OFDM waveform | amount 4, and antenna capability level 4 |
| The terminal device uses the 256QAM modulation | Maximum output power 5, power back-off |
| scheme and the DFT-s-OFDM waveform | amount 5, and antenna capability level 5 |
| The terminal device uses the QPSK modulation | Maximum output power 6, power back-off |
| scheme and the CP-OFDM waveform | amount 6, and antenna capability level 6 |
| The terminal device uses the BPSK modulation | Maximum output power 7, power back-off |
| scheme and the CP-OFDM waveform | amount 7, and antenna capability level 7 |
| The terminal device uses the 16QAM modulation | Maximum output power 8, power back-off |
| scheme and the CP-OFDM waveform | amount 8, and antenna capability level 8 |
| The terminal device uses the 64QAM modulation | Maximum output power 9, power back-off |
| scheme and the CP-OFDM waveform | amount 9, and antenna capability level 9 |
| The terminal device uses the 256QAM modulation | Maximum output power 10, power back-off |
| scheme and the CP-OFDM waveform | amount 10, and antenna capability level 10 |

In Table 5, the working condition includes the modulation scheme and the waveform that are used by the terminal device. It can be learned from Table 5 that the terminal device may support different maximum output powers, different power back-off amounts, and different antenna capability levels under different working conditions. In other words, the terminal device supports different maximum output powers, different power back-off amounts, and different antenna capability levels for different modulation schemes and/or different waveforms.

Optionally, the N groups of capability information may be indicated by using N indexes. Each of the N indexes corresponds to one of the N groups of capability information.

In a possible implementation, each of the N groups of capability information includes the maximum output power and the minimum output power that are supported by the terminal device. Each of the N groups of capability information corresponds to one working condition, and the working condition may include at least one of the foregoing at least one parameter.

For example, the terminal device indicates the N groups of capability information by using the N indexes. Details are shown in Table 6.

TABLE 6

| Index | Each group of capability information |
|---|---|
| 1 | Maximum output power 1 and minimum output power 1 |
| 2 | Maximum output power 2 and minimum output power 2 |
| 3 | Maximum output power 3 and minimum output power 3 |
| 4 | Maximum output power 4 and minimum output power 4 |
| 5 | Maximum output power 5 and minimum output power 5 |
| 6 | Maximum output power 6 and minimum output power 6 |

Each index in Table 6 corresponds to one group of capability information, and each group of capability information includes a maximum output power and a minimum output power that are supported by the terminal device under a corresponding working condition. The working condition may include the modulation scheme and the waveform that are used by the terminal device. The terminal device supports different capability information for different modulation schemes and/or different waveforms. For example, as shown in Table 6, in different groups of capability information, maximum output powers and minimum output powers that are supported by the terminal device may be different. As shown in Table 6, the index 1 indicates a first group of capability information, and the first group of capability information includes the maximum output power 1 and the minimum output power 1 that are supported by the terminal device. The index 2 indicates a second group of capability information, and the second group of capability information includes the maximum output power 2 and the minimum output power 2 that are supported by the terminal device. The index 3 indicates a third group of capability information, and the third group of capability information includes the maximum output power 3 and the minimum output power 3 that are supported by the terminal device. The index 4 indicates a fourth group of capability information, and the fourth group of capability information includes the maximum output power 4 and the minimum output power 4 that are supported by the terminal device. The index 5 indicates a fifth group of capability information, and the fifth group of capability information includes the maximum output power 5 and the minimum output power 5 that are supported by the terminal device. The index 6 indicates a sixth group of capability information, and the sixth group of capability information includes the maximum output power 6 and the minimum output power 6 of the terminal device. The terminal device may report the index 1 to the index 6 to the network device, to indicate the first group of capability information to the sixth group of capability information that are supported by the terminal device.

In another possible implementation, each of the N groups of capability information includes the maximum output power and the power back-off amount that are supported by the terminal device. Each of the N groups of capability information corresponds to one working condition, and the working condition may include at least one of the foregoing at least one parameter.

For example, the terminal device indicates the N groups of capability information by using the N indexes. Details are shown in Table 7.

TABLE 7

| Index | Each group of capability information |
|---|---|
| 1 | Maximum output power 1 and power back-off amount 1 |
| 2 | Maximum output power 2 and power back-off amount 2 |
| 3 | Maximum output power 3 and power back-off amount 3 |
| 4 | Maximum output power 4 and power back-off amount 4 |
| 5 | Maximum output power 5 and power back-off amount 5 |
| 6 | Maximum output power 6 and power back-off amount 6 |

Each index in Table 7 corresponds to one group of capability information, and each group of capability information includes a maximum output power and a power back-off amount that are supported by the terminal device under a corresponding working condition. The working condition may include the modulation scheme and the waveform that are used by the terminal device. The terminal device supports different capability information for different modulation schemes and/or different waveforms. For example, as shown in Table 7, in different groups of capability information, maximum output powers and power back-off amounts that are supported by the terminal device may be different. As shown in Table 7, the index 1 indicates a first group of capability information, and the first group of capability information includes the maximum output power 1 and the power back-off amount 1 that are supported by the terminal device. The index 2 indicates a second group of capability information, and the second group of capability information includes the maximum output power 2 and the power back-off amount 2 that are supported by the terminal device. The index 3 indicates a third group of capability information, and the third group of capability information includes the maximum output power 3 and the power back-off amount 3 that are supported by the terminal device. The index 4 indicates a fourth group of capability information, and the fourth group of capability information includes the maximum output power 4 and the power back-off amount 4 of the terminal device. The index 5 indicates a fifth group of capability information, and the fifth group of capability information includes the maximum output power 5 and the power back-off amount 5 of the terminal device. The index 6 indicates a sixth group of capability information, and the sixth group of capability information includes the maximum output power 6 and the power back-off amount 6 of the terminal device. The terminal device may report the index 1 to the index 6 to the network device, to indicate the first group of capability information to the sixth group of capability information that are supported by the terminal device.

Optionally, the N indexes may alternatively be understood as N modulation and coding scheme (modulation and coding scheme, MCS) indexes. Each of the N MCS indexes corresponds to one working condition, or each MCS index indicates one modulation and coding scheme used by the terminal device. For example, the working condition or the modulation and coding scheme includes the modulation scheme, the modulation order, the waveform, the code rate, the spectral efficiency, and/or the like that are used by the terminal device. For example, Table 1 may be represented as Table 8.

TABLE 8

| MCS index | Each group of capability information |
|---|---|
| 1 | Maximum output power 1 and minimum output power 1 |
| 2 | Maximum output power 2 and minimum output power 2 |
| 3 | Maximum output power 3 and minimum output power 3 |
| 4 | Maximum output power 4 and minimum output power 4 |
| 5 | Maximum output power 5 and minimum output power 5 |
| 6 | Maximum output power 6 and minimum output power 6 |

The MCS index 1 may correspond to one working condition. For example, the working condition corresponding to the MCS index 1 includes that the terminal device uses the QPSK modulation scheme, the modulation order used by the terminal device is 4, and the terminal device uses the DFT-s-OFDM waveform. The MCS index 2 may correspond to another working condition. For example, the working condition corresponding to the MCS index 2 includes that the terminal device uses the BPSK modulation scheme, the modulation order used by the terminal device is 2, and the terminal device uses the DFT-s-OFDM waveform. This is similar for other MCS indexes in Table 8, and details are not described herein again. It can be learned from Table 8 that each group of MCS indexes indicates one group of capability information, and different MCS indexes indicate different groups of capability information. In other words, the terminal device may support different maximum output powers and different minimum output powers under different working conditions. In other words, the terminal device may support different maximum output powers and different minimum output powers for different modulation schemes, different modulation orders, and/or different waveforms.

Optionally, one group of capability information may be considered as one terminal capability level, and the N groups of capability information may be understood as N terminal capability levels of the terminal device. Therefore, the N indexes indicate the N terminal capability levels, and each of the N indexes indicates a corresponding terminal capability level.

For example, as shown in Table 9, an index 1 indicates a terminal capability level 1, an index 2 indicates a terminal capability level 2, an index 3 indicates a terminal capability level 3, an index 4 indicates a terminal capability level 4, an index 5 indicates a terminal capability level 4, and an index 6 indicates a terminal capability level 6. Each terminal capability level corresponds to one group of capability information. Each group of capability information includes the maximum output power and the minimum output power that are supported by the terminal device. For example, the terminal capability level 1 indicates a first group of capability information, and the first group of capability information includes a maximum output power 1 and a minimum output power 1 that are supported by the terminal device. The terminal capability level 2 indicates a second group of capability information, and the second group of capability information includes a maximum output power 2 and a minimum output power 2 that are supported by the terminal device. The terminal capability level 3 indicates a third group of capability information, and the third group of capability information includes a maximum output power 3 and a minimum output power 3 that are supported by the terminal device. The terminal capability level 4 indicates a fourth group of capability information, and the fourth group of capability information includes a maximum output power 4 and a minimum output power 4 that are supported by the terminal device. The terminal capability level 5 indicates a fifth group of capability information, and the fifth group of capability information includes a maximum output power 5 and a minimum output power 5 that are supported by the terminal device. The terminal capability level 6 indicates a sixth group of capability information, and the sixth group of capability information includes a maximum output power 6 and a minimum output power 6 that are supported by the terminal device. The terminal device may report the index 1 to the index 6 to the network device, to indicate the terminal capability level 1 to the terminal capability level 6 that are supported by the terminal device, so as to indicate the six groups of capability information supported by the terminal device.

TABLE 9

| | Terminal capability | Each group of capability |
|---|---|---|
| Index | level | information |
| 1 | Terminal capability | Maximum output power 1 and |
| | level 1 | minimum output power 1 |
| 2 | Terminal capability | Maximum output power 2 and |
| | level 2 | minimum output power 2 |
| 3 | Terminal capability | Maximum output power 3 and |
| | level 3 | minimum output power 3 |
| 4 | Terminal capability | Maximum output power 4 and |
| | level 4 | minimum output power 4 |
| 5 | Terminal capability | Maximum output power 5 and |
| | level 5 | minimum output power 5 |
| 6 | Terminal capability | Maximum output power 6 and |
| | level 6 | minimum output power 6 |

In Table 9, each group of capability information includes a maximum output power and a minimum output power that are supported by the terminal device under a corresponding working condition. The working condition may include the modulation scheme and the waveform that are used by the terminal device. The terminal device supports different capability information for different modulation schemes and/or different waveforms. For example, as shown in Table 9, in different groups of capability information, maximum output powers and minimum output powers that are supported by the terminal device may be different.

For another example, as shown in Table 10, an index 1 indicates a terminal capability level 1, an index 2 indicates a terminal capability level 2, an index 3 indicates a terminal capability level 3, an index 4 indicates a terminal capability level 4, an index 5 indicates a terminal capability level 4, and an index 6 indicates a terminal capability level 6. Each terminal capability level corresponds to one group of capability information. Each group of capability information includes the maximum output power and the power back-off amount that are supported by the terminal device. For example, the terminal capability level 1 indicates a first group of capability information, and the first group of capability information includes a maximum output power 1 and a power back-off amount 1 that are supported by the terminal device. The terminal capability level 2 indicates a second group of capability information, and the second group of capability information includes a maximum output power 2 and a power back-off amount 2 that are supported by the terminal device. The terminal capability level 3 indicates a third group of capability information, and the third group of capability information includes a maximum output power 3 and a power back-off amount 3 that are supported by the terminal device. The terminal capability level 4 indicates a fourth group of capability information, and the fourth group of capability information includes a maximum output power 4 and a power back-off amount 4 that are supported by the terminal device. The terminal capability level 5 indicates a fifth group of capability information, and the fifth group of capability information includes a maximum output power 5 and a power back-off amount 5 that are supported by the terminal device. The terminal capability level 6 indicates a sixth group of capability information, and the sixth group of capability information includes a maximum output power 6 and a power back-off amount 6 that are supported by the terminal device. The terminal device may report the index 1 to the index 6 to the network device, to indicate the terminal capability level 1 to the terminal capability level 6 that are supported by the terminal device, so as to indicate the six groups of capability information supported by the terminal device.

TABLE 10

| | Terminal capability | Each group of capability |
|---|---|---|
| Index | level | information |
| 1 | Terminal capability | Maximum output power 1 and |
| | level 1 | power back-off amount 1 |
| 2 | Terminal capability | Maximum output power 2 and |
| | level 2 | power back-off amount 2 |
| 3 | Terminal capability | Maximum output power 3 and |
| | level 3 | power back-off amount 3 |
| 4 | Terminal capability | Maximum output power 4 and |
| | level 4 | power back-off amount 4 |
| 5 | Terminal capability | Maximum output power 5 and |
| | level 5 | power back-off amount 5 |
| 6 | Terminal capability | Maximum output power 6 and |
| | level 6 | power back-off amount 6 |

In Table 10, each group of capability information includes a maximum output power and a power back-off amount that are supported by the terminal device in a corresponding working condition. The working condition may include the modulation scheme and the waveform that are used by the terminal device. The terminal device supports different capability information for different modulation schemes and/or different waveforms. For example, as shown in Table 10, in different groups of capability information, maximum output powers and power back-off amounts that are supported by the terminal device may be different.

In this application, optionally, it is specified that a maximum output power of the terminal device satisfies the following condition:

$${P}_{CMAX \_ L , f , c} \leq {P}_{CMAX , f , c} \leq {P}_{CMAX \_ H , f , c} \qquad ( 1 )$$

$${P}_{CMAX \_ L , f , c} = min ( {P}_{EMAX , c} , {P}_{MOP \_ Low} , P 1 - {P}_{\_ {MPR}_{c}} )$$

$$and {P}_{CMAX \_ H , f , c} = min ( {P}_{EMAX , c} , {P}_{MOP \_ High} ) .$$

P_{EMAX,c} represents an upper limit value configured by the network device for an output power of the terminal device, a value of P_{EMAX,c} is in a range of [X, Y], X represents a minimum value of P_{EMAX,c}, and Y represents a maximum value of P_{EMAX,c}. Optionally, a unit corresponding to X and Y may be dB. Optionally, X is less than or equal to −30 dB, and Y is greater than 33 dB. For example, the value of P_{EMAX,c} is in a range of [−30 dB, 64 dB].

P_{MOP_Low} represents the minimum output power supported by the terminal device. Optionally, P_{MOP_Low} is a lowest output power in minimum output powers supported by the terminal device in various working conditions. For example, a minimum output power supported by the terminal device when the terminal device uses the QPSK modulation scheme and the DFT-s-OFDM waveform is Pa, and a minimum output power supported by the terminal device when the terminal device uses the BPSK modulation scheme and the DFT-s-OFDM waveform is Pb. Pa is greater than Pb. Therefore, P_{MOP_Low} may be equal to Pb.

P_{MOP_High} represents the maximum output power supported by the terminal device. Optionally, P_{MOP_High} is a largest output power in maximum output powers supported by the terminal device in various working conditions. For example, a maximum output power supported by the terminal device when the terminal device uses the QPSK modulation scheme and the DFT-s-OFDM waveform is Pc, and a minimum output power supported by the terminal device when the terminal device uses the BPSK modulation scheme and the DFT-s-OFDM waveform is Pd. Pc is greater than Pd. Therefore, P_{MOP_High} may be equal to Pc.

P_{_MPR}_{_{c}} represents a maximum power back-off value supported by the terminal device. Optionally, P_{_MPR}_{_{c}} is a largest power back-off value in power back-off amounts supported by the terminal device in various working conditions. For example, a power back-off amount supported by the terminal device when the terminal device uses the QPSK modulation scheme and the DFT-s-OFDM waveform is Pe, and a power back-off amount supported by the terminal device when the terminal device uses the BPSK modulation scheme and the DFT-s-OFDM waveform is Pf. Pe is greater than Pf. Therefore, P_{_MPR}_{_{c}} may be equal to Pe.

P1 is equal to P_{MOP_High} or is a maximum output power that is specified by the network device and that is supported by a terminal type of the terminal device. For example, the network device may obtain a plurality of terminal types through classification based on the N groups of capabilities reported by the terminal device. For each terminal type, the network device may specify a maximum output power supported by the terminal type. Therefore, the network device determines the terminal type of the terminal device, and determines the maximum output power supported by the type of the terminal device.

In other words, for a terminal with an ultra-high capability, in this application, a maximum output power of the terminal with an ultra-high capability is specified based on Formula (1). The upper limit value of P_{EMAX,c} is higher than an upper limit value configured by the network device for an output power of a conventional terminal device, so that the terminal with an ultra-high capability communicates with the network device by using a high output power.

In this application, optionally, it is specified that a minimum output power of the terminal device satisfies the following condition:

$${P}_{CMIN , f , c} = P 2 - {P}_{\_ {MPR}_{c}} \qquad ( 2 )$$

P2 represents a rated output power of the terminal device under the condition without power back-off, and P_{_MPR}_{_{c}} represents the maximum power back-off value supported by the terminal device. For P_{_MPR}_{_{c}}, refer to the foregoing related description.

Optionally, a value of P2 is in a range of [a, b]. Optionally, a unit corresponding to a and b may be dB. For example, a is greater than 23 dB and less than or equal to 31 dB, and b is greater than 31 dB. For example, the value of P2 is in a range of [29 dB, 60 dB].

402: The terminal device sends the N groups of capability information to the network device. Correspondingly, the network device receives the N groups of capability information from the terminal device.

Optionally, the terminal device further sends the type of the terminal device to the network device. For example, the type of the terminal device is a mobile terminal or a non-mobile terminal. Alternatively, the type of the terminal device is an airborne terminal or a handheld terminal.

403: The network device communicates with the terminal device based on the N groups of capability information.

Optionally, the network device performs power control on the terminal device based on the N groups of capability information, and/or the network device performs service type selection on the terminal device based on the N groups of capability information. For example, the network device sends power control signaling to the terminal device, where the power control signaling indicates the terminal device to communicate with the network device by using a corresponding power. For example, the network device selects a corresponding service based on the N groups of capability information reported by the terminal device, and schedules the terminal device to perform the service.

In this embodiment of this application, the terminal device supports the N groups of capability information, where N is an integer greater than or equal to 1. The terminal device may report the N groups of capability information to the network device, where each of the N groups of capability information includes at least one of the following: the rated output power, the power back-off amount, the antenna gain, the output power density, the type of the antenna in the terminal device, the maximum output power, the minimum output power, or the antenna capability level, so that the network device communicates with the terminal device based on the N groups of capability information. For example, the terminal device may be a terminal with an ultra-high capability, and the terminal with an ultra-high capability may report the N groups of capability information supported by the terminal, so that the network device communicates with the terminal with an ultra-high capability. For example, the network device performs power control and/or service type selection on the terminal with an ultra-high capability based on the N groups of capability information.

The following describes a communication apparatus provided in embodiments of this application.

FIG. 5 is a diagram of a structure of a communication apparatus according to an embodiment of this application. Refer to FIG. 5. The communication apparatus 500 may be configured to perform the processes performed by the terminal device in the embodiment shown in FIG. 4. For details, refer to the related descriptions in the foregoing method embodiment.

The communication apparatus 500 includes a processing module 501 and a transceiver module 502.

The processing module 501 is configured to process data. The transceiver module 502 may implement a corresponding communication function. The transceiver module 502 may also be referred to as a communication interface or a communication module.

Optionally, the communication apparatus 500 may further include a storage module. The storage module may be configured to store instructions and/or data. The processing module 501 may read the instructions and/or the data in the storage module, to enable the communication apparatus to implement the foregoing method embodiment.

The communication apparatus 500 may be configured to perform the actions performed by the terminal device in the foregoing method embodiment. The communication apparatus 500 may be the terminal device or a component that may be disposed in the terminal device. The processing module 501 is configured to perform the processing-related operation on a terminal device side in the foregoing method embodiment. The transceiver module 502 is configured to perform the receiving-related operation on the terminal device side in the foregoing method embodiment. For example, the communication apparatus 500 is configured to perform the following solution.

The processing module 501 is configured to determine N groups of capability information, where each of the N groups of capability information includes at least one of the following: a rated output power, a power back-off amount, an antenna gain, an output power density, a type of an antenna in the communication apparatus 500, a maximum output power, a minimum output power, or an antenna capability level, and N is an integer greater than or equal to 1.

The transceiver module 502 is configured to send the N groups of capability information to a network device.

Optionally, the transceiver module 502 may include a sending module and a receiving module. The sending module is configured to perform the sending operation in the foregoing method embodiment. The receiving module is configured to perform the receiving operation in the foregoing method embodiment.

It needs to be noted that the communication apparatus 500 may include the sending module but does not include the receiving module. Alternatively, the communication apparatus 500 may include the receiving module but does not include the sending module. This may be specifically determined based on whether the foregoing solution performed by the communication apparatus 500 includes a sending action and a receiving action.

Optionally, the communication apparatus 500 is configured to perform the actions performed by the terminal device in the embodiment shown in FIG. 4. For details, refer to related descriptions in the embodiment shown in FIG. 4 above. Details are not described herein.

It should be understood that a specific process in which the modules perform the foregoing corresponding processes has been described in detail in the foregoing method embodiment. For brevity, details are not described herein again.

The processing module 501 in the foregoing embodiment may be implemented by at least one processor or processor-related circuit. The transceiver module 502 may be implemented by a transceiver or a transceiver-related circuit. The transceiver module 502 may also be referred to as a communication module or a communication interface. The storage module may be implemented by at least one memory.

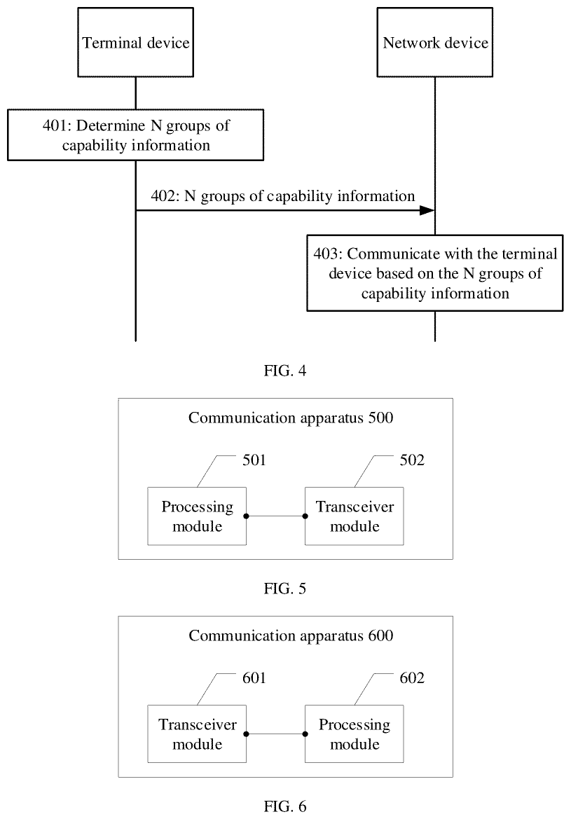

FIG. 6 is a diagram of another structure of a communication apparatus according to an embodiment of this application. Refer to FIG. 6. The communication apparatus 600 may be configured to perform the processes performed by the network device in the embodiment shown in FIG. 4. For details, refer to the related descriptions in the foregoing method embodiment.

The communication apparatus 600 includes a transceiver module 601 and a processing module 602.

The processing module 602 is configured to process data. The transceiver module 601 may implement a corresponding communication function. The transceiver module 601 may also be referred to as a communication interface or a communication module.

Optionally, the communication apparatus 600 may further include a storage module. The storage module may be configured to store instructions and/or data. The processing module 602 may read the instructions and/or the data in the storage module, to enable the communication apparatus to implement the foregoing method embodiment.

The communication apparatus 600 may be configured to perform the actions performed by the network device in the foregoing method embodiment. The communication apparatus 600 may be a network device or a component that may be disposed in the network device. The processing module 602 is configured to perform the processing-related operation on a network device side in the foregoing method embodiment. The transceiver module 601 is configured to perform the receiving-related operation on the network device side in the foregoing method embodiment. For example, the communication apparatus 600 is configured to perform the following solution.

The transceiver module 601 is configured to receive N groups of capability information from a terminal device, where each of the N groups of capability information includes at least one of the following: a rated output power, a power back-off amount, an antenna gain, an output power density, a type of an antenna in the terminal device, a maximum output power, a minimum output power, or an antenna capability level, and N is an integer greater than or equal to 1.

The processing module 602 is configured to communicate with the terminal device based on the N groups of capability information.

Optionally, the transceiver module 601 may include a sending module and a receiving module. The sending module is configured to perform the sending operation in the foregoing method embodiment. The receiving module is configured to perform the receiving operation in the foregoing method embodiment.

It needs to be noted that the communication apparatus 600 may include the sending module but does not include the receiving module. Alternatively, the communication apparatus 600 may include the receiving module but does not include the sending module. This may be specifically determined based on whether the foregoing solution performed by the communication apparatus 600 includes a sending action and a receiving action.

Optionally, the communication apparatus 600 is configured to perform the actions performed by the network device in the embodiment shown in FIG. 4. For details, refer to related descriptions in the embodiment shown in FIG. 4 above. Details are not described herein.

It should be understood that a specific process in which the modules perform the foregoing corresponding processes has been described in detail in the foregoing method embodiment. For brevity, details are not described herein again.

The processing module 602 in the foregoing embodiment may be implemented by at least one processor or processor-related circuit. The transceiver module 601 may be implemented by a transceiver or a transceiver-related circuit. The transceiver module 601 may also be referred to as a communication module or a communication interface. The storage module may be implemented by at least one memory.

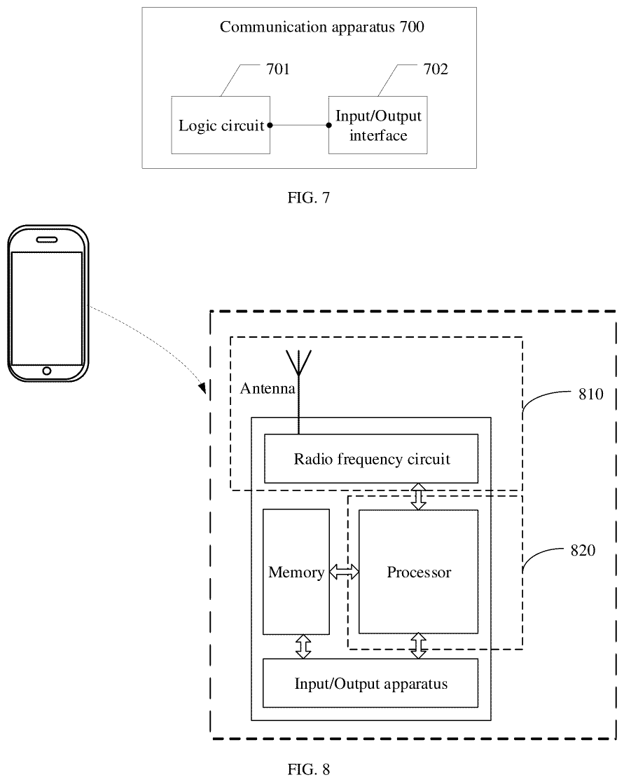

FIG. 7 is a diagram of another structure of a communication apparatus according to an embodiment of this application. Refer to FIG. 7. The communication apparatus 700 includes a logic circuit 701 and an input/output interface 702.

In a possible implementation, the communication apparatus 700 shown in FIG. 7 may be configured to perform the steps performed by the terminal device in the embodiment shown in FIG. 4. The logic circuit 701 may have a function of the processing module 501 in the embodiment shown in FIG. 5, and the input/output interface 702 may have a function of the transceiver module 502 in the embodiment shown in FIG. 5.

In another possible implementation, the communication apparatus 700 shown in FIG. 7 may be configured to perform the steps performed by the network device in the embodiment shown in FIG. 4. The logic circuit 701 may have a function of the processing module 602 in the embodiment shown in FIG. 6, and the input/output interface 702 may have a function of the transceiver module 601 in the embodiment shown in FIG. 6.

The communication apparatus shown in FIG. 7 may perform the technical solutions shown in the foregoing method embodiment. An implementation principle and beneficial effects of the communication apparatus are similar to those of the foregoing method embodiment, and details are not described herein again.

The following shows a diagram of a possible structure of a terminal device with reference to FIG. 8.

FIG. 8 is a diagram of a structure of a terminal device according to an embodiment of this application. For ease of understanding and figure illustration, an example in which the terminal device is a mobile phone is used in FIG. 8. As shown in FIG. 8, the terminal device includes a processor, a memory, a radio frequency circuit, an antenna, and an input/output apparatus.

The processor is mainly configured to: process a communication protocol and communication data, control the terminal device, execute a software program, process data of the software program, and the like.

The memory is mainly configured to store the software program and data. The radio frequency circuit is mainly configured to: perform conversion between a baseband signal and a radio frequency signal, and process the radio frequency signal. The antenna is mainly configured to receive and send a radio frequency signal in a form of electromagnetic wave.

The input/output apparatus, such as a touchscreen, a display, or a keyboard, is mainly configured to: receive data input by a user and output data to the user. It should be noted that some types of terminal devices may have no input/output apparatus.

When needing to send data, after performing baseband processing on the to-be-sent data, the processor outputs a baseband signal to the radio frequency circuit; and the radio frequency circuit performs radio frequency processing on the baseband signal and then sends a radio frequency signal to the outside in a form of electromagnetic wave through the antenna. When data is sent to the terminal device, the radio frequency circuit receives the radio frequency signal through the antenna, converts the radio frequency signal into a baseband signal, and outputs the baseband signal to the processor. The processor converts the baseband signal into data, and processes the data.

For ease of description, FIG. 8 shows only one memory and one processor. In an actual terminal device product, there may be one or more processors and one or more memories. The memory may also be referred to as a storage medium, a storage device, or the like. The memory may be disposed independent of the processor, or may be integrated with the processor. This is not limited in embodiments of this application.

In embodiments of this application, the antenna and the radio frequency circuit that have receiving and sending functions may be considered as a transceiver unit of the terminal device, and the processor that has a processing function may be considered as a processing unit of the terminal device. As shown in FIG. 8, the terminal device includes a transceiver unit 810 and a processing unit 820. The transceiver unit may also be referred to as a transceiver, a transceiver machine, a transceiver apparatus, or the like. The processing unit may also be referred to as a processor, a processing board, a processing module, a processing apparatus, or the like. Optionally, a component that is in the transceiver unit 810 and that is configured to implement a receiving function may be considered as a receiving unit, and a component that is in the transceiver unit 810 and that is configured to implement a sending function may be considered as a sending unit. In other words, the transceiver unit 810 includes the receiving unit and the sending unit. The transceiver unit sometimes may also be referred to as a transceiver machine, a transceiver, a transceiver circuit, or the like. The receiving unit sometimes may also be referred to as a receiver, a receiver machine, a receiver circuit, or the like. The sending unit sometimes may also be referred to as a transmitter, a transmitter machine, a transmitter circuit, or the like.

It should be understood that, the transceiver unit 810 is configured to perform the sending operation and the receiving operation of the terminal device in the foregoing method embodiment, and the processing unit 820 is configured to perform another operation, other than the receiving and sending operations, of the terminal device in the foregoing method embodiment.

When the terminal device is a chip, the chip includes a transceiver unit and a processing unit. The transceiver unit may be an input/output circuit or a communication interface. The processing unit is a processor, a microprocessor, an integrated circuit, or a logic circuit integrated on the chip.

This application further provides a communication apparatus 900. The communication apparatus 900 may be a network device or a chip. The communication apparatus 900 may be configured to perform the operations performed by the network device in the embodiment shown in FIG. 4.

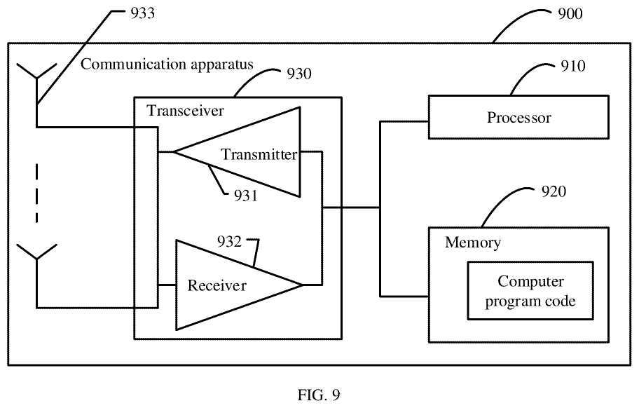

When the communication apparatus 900 is an access network device, for example, a base station, FIG. 9 is a diagram of a simplified structure of the base station. Refer to FIG. 9. The base station includes a part 910, a part 920, and a part 930.

The part 910 is mainly configured to: perform baseband processing, control the base station, and the like. The part 910 is usually a control center of the base station, may be usually referred to as a processor, and is configured to control the base station to perform the processing operation on a network device side in the foregoing method embodiment.

The part 920 is mainly configured to store computer program code and data.

The part 930 is mainly configured to: receive and send a radio frequency signal and perform conversion between a radio frequency signal and a baseband signal. The part 930 may be usually referred to as a transceiver module, a transceiver machine, a transceiver circuit, a transceiver, or the like. The transceiver module in the part 930 may also be referred to as a transceiver machine, a transceiver, or the like. The transceiver module includes an antenna 933 and a radio frequency circuit (not shown in the figure). The radio frequency circuit is mainly configured to perform radio frequency processing. Optionally, a component that is in the part 930 and that is configured to implement a receiving function may be considered as a receiver, and a component that is in the part 930 and that is configured to implement a sending function may be considered as a transmitter. In other words, the part 930 includes a receiver 932 and a transmitter 931. The receiver may also be referred to as a receiving module, a receiver machine, a receiver circuit, or the like, and the transmitter may be referred to as a transmitting module, a transmitter machine, a transmitter circuit, or the like.

The part 910 and the part 920 may include one or more boards, and each board may include one or more processors and one or more memories. The processor is configured to read and execute a program in the memory, to implement a baseband processing function and control the base station. If there are a plurality of boards, the boards may be interconnected with each other to enhance a processing capability. In an optional implementation, a plurality of boards may share one or more processors, or a plurality of boards share one or more memories, or a plurality of boards share one or more processors at the same time.

For example, in an implementation, the transceiver module in the part 930 is configured to perform the receiving and sending-related process performed by the network device in the embodiment FIG. 4. A processor in the part 910 is configured to perform the processing-related process performed by the network device in the embodiment shown in FIG. 4.

It should be understood that FIG. 9 is merely an example rather than a limitation, and the network device including the processor, the memory, and the transceiver may not depend on the structure shown in FIG. 6 or FIG. 9.

When the communication apparatus 900 is a chip, the chip includes a transceiver, a memory, and a processor. The transceiver may be an input/output circuit or a communication interface. The processor is a processor, a microprocessor, or an integrated circuit integrated on the chip. The sending operation performed by the network device in the foregoing method embodiment may be understood as output of the chip, and the receiving operation performed by the network device in the foregoing method embodiment may be understood as input of the chip.

An embodiment of this application further provides a computer-readable storage medium. The computer-readable storage medium stores computer instructions for implementing the method performed by the terminal device or the network device in the foregoing method embodiment.

For example, when the computer program is executed by a computer, the computer is enabled to implement the method performed by the terminal device or the network device in the foregoing method embodiment.

An embodiment of this application further provides a computer program product including instructions. When the instructions are executed by a computer, the computer is enabled to implement the method performed by the terminal device or the network device in the foregoing method embodiment.

An embodiment of this application further provides a communication system. The communication system includes the terminal device in the foregoing embodiment and the network device in the foregoing embodiment.

An embodiment of this application further provides a chip apparatus including a processor, configured to invoke a computer program or computer instructions stored in a memory, to enable the processor to perform the method in the embodiment shown in FIG. 4.

In a possible implementation, input of the chip apparatus corresponds to the receiving operation in the embodiment shown in FIG. 4, and output of the chip apparatus corresponds to the sending operation in the embodiment shown in FIG. 4.

Optionally, the processor is coupled to the memory through an interface.

Optionally, the chip apparatus further includes the memory, and the memory stores the computer program or the computer instructions.

Any processor mentioned above may be a general-purpose central processing unit, a microprocessor, an application-specific integrated circuit (application-specific integrated circuit, ASIC), or one or more integrated circuits configured to control program execution of the method in the embodiment shown in FIG. 4. The memory mentioned in any one of the foregoing may be a read-only memory (read-only memory, ROM), another type of static storage device that can store static information and instructions, a random access memory (random access memory, RAM), or the like.

It may be clearly understood by persons skilled in the art that, for convenient and brief description, for explanations and beneficial effects of related content in any one of the communication apparatuses provided above, refer to the corresponding method embodiment provided above. Details are not described herein again.

In several embodiments provided in this application, it should be understood that the disclosed system, apparatus, and method may be implemented in other manners. For example, the described apparatus embodiments are merely examples. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of embodiments.

In addition, functional units in embodiments of this application may be integrated into one processing unit, or each of the units may exist alone physically, or two or more units may be integrated into one unit. The integrated unit may be implemented in a form of hardware, or may be implemented in a form of software functional unit.

When the integrated unit is implemented in the form of software functional unit and sold or used as an independent product, the integrated unit may be stored in a computer-readable storage medium. Based on such an understanding, the technical solutions in this application essentially, the part contributing, or all or some of the technical solutions may be implemented in a form of a software product. The computer software product is stored in a storage medium, and includes several instructions for instructing a computer device (which may be a personal computer, a server, or a network device) to perform all or some of the steps of the methods in embodiments of this application. The foregoing storage medium includes any medium that can store program code, such as a USB flash drive, a removable hard disk, a ROM, a RAM, a magnetic disk, or an optical disc.

In conclusion, the foregoing embodiments are merely intended for describing the technical solutions of this application, but not for limiting this application. Although this application is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of embodiments of this application.

1. A method, wherein the method comprises:
determining, by a terminal device, N groups of capability information, wherein each of the N groups of capability information includes at least one of the following: a rated output power, a power back-off amount, an antenna gain, an output power density, a type of an antenna in the terminal device, a maximum output power, a minimum output power, or an antenna capability level, and N is an integer greater than or equal to 1; and
sending, by the terminal device, the N groups of capability information to a network device.

2. The method according to claim 1, wherein the terminal device supports Nmax groups of capability information, N is less than or equal to Nmax, and Nmax is an integer greater than or equal to 2.

3. The method according to claim 1, wherein the N groups of capability information includes N indexes, and each of the N indexes corresponds to one of the N groups of capability information.

4. The method according to claim 1, wherein in the N groups of capability information, different groups of capability information differ in at least one of the following corresponding parameters, wherein
at least one parameter includes at least one of the following: a modulation scheme usable by the terminal device, a modulation order usable by the terminal device, a code rate used by the terminal device, spectral efficiency usable by the terminal device, a waveform usable by the terminal device, a polarization manner usable by the terminal device, a position of a time-frequency resource allocated to the terminal device, a communication scenario of the terminal device, or a motion status of the terminal device.

5. The method according to claim 1, wherein a maximum output power P_{CMAX,f,c} of the terminal device satisfies the following condition:
$${P}_{CMAX \_ L , f , c} \leq {P}_{CMAX , f , c} \leq {P}_{CMAX \_ H , f , c} , wherein$$
$${P}_{CMAX \_ L , f , c} = min ( {P}_{EMAX , c} , {P}_{MOP \_ Low} , P 1 - {P}_{\_ {MPR}_{c}} ) ,$$
P_{CMAX_H,f,c}=min(P_{EMAX,c}, P_{MOP_High}), P_{EMAX,c} represents an upper limit value configured by the network device for an output power of the terminal device, a value of P_{EMAX,c} is in a range of [X, Y], X represents a minimum value of P_{EMAX,c}, Y represents a maximum value of P_{EMAX,c}, P_{MOP_Low} represents a minimum output power supported by the terminal device, P_{MOP_High} represents a maximum output power supported by the terminal device, P_{_MPR}_{_{c}} represents a maximum power back-off value supported by the terminal device, and P1 is equal to P_{MOP_High} or is a maximum output power that is specified by the network device and that is supported by a terminal type of the terminal device;
wherein X is less than or equal to −30 decibels dB, and Y is greater than 33 dB.

6. The method according to claim 1, wherein a minimum output power P_{CMIN,f,c} of the terminal device satisfies the following condition:
$${P}_{CMIN , f , c} = P 2 - {P}_{\_ {MPR}_{c}} ,$$
wherein
P2 represents a rated output power of the terminal device under a condition without power back-off, and P_{_MPR}_{_{c}} represents a maximum power back-off value supported by the terminal device;
wherein a value of P2 is in a range of [a, b], a is greater than 23 dB and less than or equal to 31 dB, and b is greater than 31 dB.

7. The method according to claim 1, wherein the type of the antenna in the terminal device includes one or more of the following: a parabolic antenna, a phased-array antenna, an omnidirectional antenna, a directional antenna, an active antenna, or a passive antenna.

8. An apparatus, comprising:
at least one processor; and
one or more memories coupled to the at least one processor and storing programming instructions for execution by the at least one processor to:
determine N groups of capability information, wherein each of the N groups of capability information includes at least one of the following: a rated output power, a power back-off amount, an antenna gain, an output power density, a type of an antenna in a terminal device, a maximum output power, a minimum output power, or an antenna capability level, and N is an integer greater than or equal to 1; and
send the N groups of capability information to a network device.

9. The apparatus according to claim 8, wherein the terminal device supports Nmax groups of capability information, N is less than or equal to Nmax, and Nmax is an integer greater than or equal to 2.

10. The apparatus according to claim 8, wherein the N groups of capability information includes N indexes, and each of the N indexes corresponds to one of the N groups of capability information.

11. The apparatus according to claim 8, wherein in the N groups of capability information, different groups of capability information differ in at least one of the following corresponding parameters, wherein
at least one parameter includes at least one of the following: a modulation scheme usable by the terminal device, a modulation order usable by the terminal device, a code rate usable by the terminal device, spectral efficiency usable by the terminal device, a waveform usable by the terminal device, a polarization manner usable by the terminal device, a position of a time-frequency resource allocated to the terminal device, a communication scenario of the terminal device, or a motion status of the terminal device.

12. The apparatus according to claim 8, wherein a maximum output power P_{CMAX,f,c} of the terminal device satisfies the following condition:
$${P}_{CMAX \_ L , f , c} \leq {P}_{CMAX , f , c} \leq {P}_{CMAX \_ H , f , c} , wherein$$
$${P}_{CMAX \_ L , f , c} = min ( {P}_{EMAX , c} , {P}_{MOP \_ Low} , P 1 - {P}_{\_ {MPR}_{c}} ) ,$$
P_{CMAX_H,f,c}=min(P_{EMAX,c}, P_{MOP_High}), P_{EMAX,c} represents an upper limit value configured by the network device for an output power of the terminal device, a value of P_{EMAX,c} is in a range of [X, Y], X represents a minimum value of P_{EMAX,c}, Y represents a maximum value of P_{EMAX,c}, P_{MOP_Low} represents a minimum output power supported by the terminal device, P_{MOP_High} represents a maximum output power supported by the terminal device, P_{_MPR}_{_{c}} represents a maximum power back-off value supported by the terminal device, and P1 is equal to P_{MOP_High} or is a maximum output power that is specified by the network device and that is supported by a terminal type of the terminal device;
wherein X is less than or equal to −30 decibels dB, and Y is greater than 33 dB.

13. The apparatus according to claim 8, wherein a minimum output power P_{CMIN,f,c} of the terminal device satisfies the following condition:
$${P}_{CMIN , f , c} = P 2 - {P}_{\_ {MPR}_{c}} ,$$
wherein
P2 represents a rated output power of the terminal device under a condition without power back-off, and P_{_MPR}_{_{c}} represents a maximum power back-off value supported by the terminal device;
wherein a value of P2 is in a range of [a, b], a is greater than 23 dB and less than or equal to 31 dB, and b is greater than 31 dB.

14. An apparatus, comprising:
at least one processor; and
one or more memories coupled to the at least one processor and storing programming instructions for execution by the at least one processor to:
receive N groups of capability information from a terminal device, wherein each of the N groups of capability information includes at least one of the following: a rated output power, a power back-off amount, an antenna gain, an output power density, a type of an antenna in the terminal device, a maximum output power, a minimum output power, or an antenna capability level, and N is an integer greater than or equal to 1; and
communicate with the terminal device based on the N groups of capability information.

15. The apparatus according to claim 14, wherein the terminal device supports Nmax groups of capability information, N is less than or equal to Nmax, and Nmax is an integer greater than or equal to 2.

16. The apparatus according to claim 14, wherein the N groups of capability information include N indexes, and each of the N indexes corresponds to one of the N groups of capability information.

17. The apparatus according to claim 14, wherein in the N groups of capability information, different groups of capability information differ in at least one of the following corresponding parameters, wherein
at least one parameter includes at least one of the following: a modulation scheme usable by the terminal device, a modulation order usable by the terminal device, a code rate usable by the terminal device, spectral efficiency usable by the terminal device, a waveform usable by the terminal device, a polarization manner usable by the terminal device, a position of a time-frequency resource allocated to the terminal device, a communication scenario of the terminal device, or a motion status of the terminal device.

18. The apparatus according to claim 14, wherein a maximum output power P_{CMAX,f,c} of the terminal device satisfies the following condition:
$${P}_{CMAX \_ L , f , c} \leq {P}_{CMAX , f , c} \leq {P}_{CMAX \_ H , f , c} , wherein$$
$${P}_{CMAX \_ L , f , c} = min ( {P}_{EMAX , c} , {P}_{MOP \_ Low} , P 1 - {P}_{\_ {MPR}_{c}} ) ,$$
P_{CMAX_H,f,c}=min(P_{EMAX,c}, P_{MOP_High}), P_{EMAX,c} represents an upper limit value configured by a network device for an output power of the terminal device, a value of P_{EMAX,c} is in a range of [X, Y], X represents a minimum value of P_{EMAX,c}, Y represents a maximum value of P_{EMAX,c}, P_{MOP_Low} represents a minimum output power supported by the terminal device, P_{MOP_High} represents a maximum output power supported by the terminal device, P_{_MPR}_{_{c}} represents a maximum power back-off value supported by the terminal device, and P1 is equal to P_{MOP_High} or is a maximum output power that is specified by the network device and that is supported by a terminal type of the terminal device;
wherein X is less than or equal to −30 decibels dB, and Y is greater than 33 dB.

19. The apparatus according to claim 14, wherein a minimum output power P_{CMIN,f,c} of the terminal device satisfies the following condition:
$${P}_{CMIN , f , c} = P 2 - {P}_{\_ {MPR}_{c}} ,$$
P2 represents a rated output power of the terminal device under a condition without power back-off, and P_{_MPR}_{_{c}} represents a maximum power back-off value supported by the terminal device;
wherein a value of P2 is in a range of [a, b], a is greater than 23 dB and less than or equal to 31 dB, and b is greater than 31 dB.

20. The apparatus according to claim 14, wherein the type of the antenna in the terminal device includes one or more of the following: a parabolic antenna, a phased-array antenna, an omnidirectional antenna, a directional antenna, an active antenna, or a passive antenna.
